(19) United States
(12) Patent Application Publication
(10) Pub. No.: US 2015/0278263 A1
(43) Pub. Date: Oct. 1, 2015

(54) ACTIVITY ENVIRONMENT AND DATA SYSTEM FOR USER ACTIVITY PROCESSING

(71) Applicants: Brian Bowles, Kent, OH (US); Donald Bowles, Kent, OH (US); Gary Mest, Wadswoth, OH (US); Alisha Nicole Konya, Kent, OH (US)

(72) Inventors: Brian Bowles, Kent, OH (US); Donald Bowles, Kent, OH (US); Gary Mest, Wadswoth, OH (US); Alisha Nicole Konya, Kent, OH (US)

(21) Appl. No.: 14/667,660

(22) Filed: Mar. 24, 2015

Related U.S. Application Data
(60) Provisional application No. 61/970,073, filed on Mar. 25, 2014.

(51) Int. Cl. G06F 17/30; A63F 13/60

(52) U.S. Cl. CPC G06F 17/30312; G06F 17/30345; A63F 13/60

(57) ABSTRACT

A configurable activity environment that enables training and gameplay. The environment comprises an activity area of barriers and obstacles in which user activities are conducted. A sensor system is dispersed in association with the activity area to sense user status (e.g., moving, stationary, etc.) and activity area information (e.g., number of users in the area, environmental conditions, barrier and obstacle layout and locations, etc.) as part of the user activities in the activity area. The user equipment can be assigned to each user active in the activity area and for performing the user activities in the activity area. Moreover, the user equipment can be for different purposes or functions, such as medic, shooter, and so on, when employed in a tactical game, police training, simply for game play, etc. The user equipment stores and provides user activity data and user status data of the user during the user activities in the activity area.

### CROSS-REFERENCE TO RELATED APPLICATIONS

This application claims the benefit of pending U.S. Provisional Patent application Ser. No. 61/970,073 entitled “ACTIVITY ENVIRONMENT AND DATA SYSTEM FOR USER ACTIVITY PROCESSING” and filed Mar. 25, 2014, the entirety of which is incorporated by reference herein.

### BACKGROUND

Users are seeking ways in which to not only participate in more realistic situational play but to also obtain assessment of user skills during that participation. For example, one type of game that has seen increased popularity is paintball, where users function as solo players or as teams to achieve certain goals. The capability to participate in more realistic scenarios also finds particular application to the training of personnel of law enforcement agencies, the military, and first responders, such as fire training, for example.

However, existing implementations lack the capability to readily adapt to physical changes in the area of the activity, field, or arena, and to enable the detailed capture of data for the users, area of activity situations, and overall assessment of the activity and users.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Disclosed is a configurable activity environment that enables at least training and gameplay. The environment comprises an activity area of barriers and obstacles in which user activities are conducted. A sensor system is dispersed in association with the activity area to sense user status (e.g., moving, stationary, etc.) and activity area information (e.g., number of users in the area, environmental conditions, barrier and obstacle layout and locations, etc.) as part of the user activities in the activity area.

The user equipment can be assigned to each user active in the activity area and for performing the user activities in the activity area. Moreover, the user equipment can be for different purposes or functions or user roles in the activity area, such as medic, shooter, and so on, when employed in a tactical game, police training, simply for game play, etc. The user equipment stores and provides user activity data and user status data of the user for any given user role during the user activities in the activity area.

A data acquisition and control (DAC) system can be employed in communication (wired and/or wireless) with the sensor system and the user equipment to process received sensor data, compute activity information, and communicate activity parameters to the activity area and users. The DAC system can comprise a network (e.g., mesh, autonomous, etc.) that connects to the activity environment for various purposes. In one implementation, the sensor system utilizes RFID (radio frequency identification) technology for readers and active/passive chips (RFID tags) for the user equipment and the sensors located throughout the activity area. As users pass in proximity to certain sensors (e.g., RFID readers) in the activity area, the RFID tag data stored as part of the user equipment is read (activated by the reader), and communicated to the DAC system. Thus, user location through the activity area can be tracked as well as other user data written into the RFID tag at the desired locations and times.

The user status data such as medical supplies, biometrics (e.g., body temperature, muscle activity, cardio and pulmonary activity, etc.) can be read via user equipment sensors and written into the RFID tag for reading, when in suitable proximity of an RFID reader located in the activity area. It is to be understood that the architecture is not limited to RFID technology, but can comprise any suitable short range communications wireless technology such as Blutetooth™, for example.

The user equipment can also include microphone systems (e.g., as part of wireless headsets) that enable users to intercommunicate during user activities in the activity area, as well as to communicate with a supervisor (or administrator) who may be overseeing (administering) or monitoring the user activities.

The user equipment can comprise activity tools/devices such as guns (laser), personal recording devices such as for audio and video recording, activity sensitive armor that senses a “hit” if targeted by another user, a user equipment control system that interconnects one or more of the user equipment for control, data acquisition, and configuration, personal health sensors that may operate in combination with the medical status and/or wound status of a user during activities, for example.

The activity area may also include sensors such as cameras and audio equipment configured to capture user voice activity and movement in the activity area. The activity area may also comprise floor and/or surface sensors that identify and/or trace user steps (movement) during activities. This finds particular applicability to activity environments configured to include traps, mines, trip wires, sonic sensors, motion sensors, light sensors, glass break sensors, pressure sensors, etc.

The DAC system includes various software components (e.g., programs) that enable the creation of activity scenarios for the activities in the activity area, the activity area layout for barriers and obstacles, number of users, user roles, user equipment, parameters, network configuration and communications, sensor settings and configuration, data acquisition, data processing for output and presentation to a user interface (UI) not only for the users during activities, but also to an activity administrator, etc.

The activity environment can be setup and configured according to scenarios defined by one or more activity sets. For example, an activity set for a tactical training environment can include the number of participants, starting participant locations, difficulty of the activity set (e.g., novice, expert, etc.), roles of the participants, the physical layout, structure and components of the activity area (e.g., single floor, multi-floor, outdoor field layout, etc.), environmental conditions (e.g., cold, rain, fog, etc.), type of communications enabled, weapons to be used, if at all, opposing user or team, and so on.

Additionally, each activity can be defined according to one or more activity sets. For example, one activity scenario may utilize only a predetermined set of sensors, defined as an activity set (for sensors). Additionally, that scenario can utilize predetermined communications settings and hardware defined according to another activity set, and specific user equipment configurations, user (participant) roles, defined according to yet another activity set, and so on. Thus, the DAC system can then be configured by these one or more activity sets to setup (configure) the entire activity for a given activity area.

The DAC system can access one or more activity sets from an object, which is defined as a one or many of the following states, for example, location, direction, angle, muscle movements, gestures or relational proximity of any object that is being tracked, and so on. The objects can provide functionality that ranges from a person to robotic arm making hand and/or arm gestures. In one implementation, activity sets can be collected through third party hardware/software that tracks location, direction, angle, proximity, muscle movements, and/or gestures, to name just a few.

The system can use activity sets separately and with other activity sets to determine what data is to be accessed and or manipulated. For an object to access and or manipulate the data of another object, an object can be configured to meet the predetermined activity set relationship assigned to those objects. Once the activity set relationship criteria is met, the objects can then access and or manipulate the data that is associated with the object with which the object interfaces.

A single or collective grouping of activities can be assigned to the data in a database, which can be referred to as “situations”. In addition to the linking of activities to the data, the method in which the data will be accessed and executed can also be defined. When an object(s) that is being tracked performs the activity/activities assigned to the data then that specified data is accessed, manipulated, executed and/or any combination of the above. The actions are carried out using the data performed to or with the object(s) that are linked to the situation. This can be the object(s) that performed the activities, a separate object(s), or both.

As can be applied to games by users in physical areas, a game interactive environment and architecture is disclosed in which a game area or arena can be configured for physical interaction of players (users). The architecture comprises game data acquisition and status updates in realtime (at to near the time the action is occurring) so that users are readily apprised of changes in the game. Accordingly, player tactics can also be adjusted to improve user and/or team advantages over opposing users and/or teams.

The interactive game environment can include a network of detection devices (e.g., a mesh network) suitably installed, configured, located, and networked (wired and/or wirelessly) that detect at least the nearby presence of a user operating in the game environment. The detection technology can include, but is not limited to, RFID, and geographic location (geolocation) technologies that employ geographical coordinates (latitude/longitude) such as GPS (global positioning system), geofences, and triangulation technology (e.g., wireless signal strength, audio signal detection, etc.) that enable the identification of the physical location of a player in the game environment.

Additionally, each user is outfitted with a personal game system (user equipment) that enables play (and role play) according to the environment and architecture capabilities. The personal game system employs the hardware/software that facilitates the game play using some or all of the architecture capabilities.

An administrative or supervisory component enables an activity supervisor to not only monitor physical activities in a specific setting (e.g., law enforcement certification) but to also change the parameters of the activity dynamically as the activity session progresses. For example, if a team member of a two-man team becomes incapacitated, activities can be changed to then monitor the activities/behavior of the other team member in this given situation as to care and security, for example.

In an alternative implementation, a 3D (three-dimensional) game engine can be employed to digitally recreate the physical environments and the people (participants) that are in the physical environment. The users are digitally recreated using a wireless motion capture suit being worn.Error! Hyperlink reference not valid. Thus, the activity appears like a video game. All data received from the physical devices, objects, and people, is mapped directly to their digital counterpart, which is then moved (animated) in accordance to the data the digital counterpart and 3D engine receives. For example when a player runs across a room, the 3D version of the player in the digitally recreated environment will appear to also run across the room in the same heading and speed.

When a player fires a gun, the digitally created version also fires. Once fired in the digital environment, the game engine replicates the bullet using bullet physics. If the location of the bullet and the person are in the same location at the same time, the 3D engine uses the last recorded body position of the person to determine where the bullet hit. Once hit, the 3D engine sends a command to that player's vest to activate the corresponding motor. The 3D engine also tracks all interactions within the digital environment and once a predetermined situation occurs the 3D engine sends the commands to trigger the corresponding devices to trigger the events that occurred in the digital environment.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an exemplary implementation of user equipment in accordance with the disclosed architecture.

FIG. 3 illustrates a light sensing component of an exemplary target subsystem.

FIG. 4A illustrates a gun function flowchart.

FIG. 4B illustrates a flowchart for a physical magazine reload operation.

FIG. 4C illustrates a flowchart for an electronic magazine reload operation.

FIG. 5 illustrates a flow diagram for sensor input of body hits.

FIG. 6 illustrates a supervisory interface for a training activity.

FIG. 7 illustrates the supervisory interface where the supervisor expanded the status information panel for an officer.

FIG. 8 illustrates the supervisor interface where the participant status information for a participant displays other information.

FIG. 9 illustrates a different interface view of the supervisory interface as a configuration page.

FIG. 10 illustrates the configuration page as finally submitted to the database to effect actions for the participants for the specific moment in time for the session.

FIG. 11 illustrates a setup page for generating a session.

FIG. 12 illustrates a participant configuration page that enables rules to be configured for behaviors and actions of officers in various scenarios.

FIG. 13 illustrates a different view of the participant the configuration page where rules can be set for the attackers.

FIG. 14 illustrates a statistics view selection page that enables the selection of a statistics view for a single officer or all officers.

FIG. 15 illustrates a statistical view of an officer selected in the statistical view selection page of FIG. 14.

FIG. 16 illustrates a tabular representation of groupings of an officer against multiple attackers encountered during the session using the statistics shown in FIG. 15.

FIG. 17 illustrates a portable device that can be used to access aspects of the session in the activity area.

FIG. 18 illustrates a system where the application of the disclosed architecture can be employed to physical gameplay or training can be realized using computerized gameplay or training and corresponding virtual avatars.

FIG. 19 illustrates a method in accordance with the disclosed architecture.

FIG. 20 illustrates is illustrated a block diagram of a computing system that enables setup, configuration and user interaction with an activity environment and data acquisition for user activity processing in an activity area in accordance with the disclosed architecture.

### DETAILED DESCRIPTION

Disclosed is a configurable activity environment that enables training and gameplay. The environment comprises a user-configurable activity area of barriers and obstacles in which user activities are conducted. A sensor system is provided that can be dispersed in association with the activity area to sense user status (e.g., moving, stationary, wounded, ammunition status, etc.), user roles, and activity area information (e.g., number of users in the area, environmental conditions, barrier and obstacle layout and locations, etc.) as part of the user activities in the activity area.

The user equipment can be assigned to each user active in the activity area according to the user role (e.g., medic) and for performing the user activities (e.g., performing medic activities) in the activity area. Moreover, the user equipment can be for different purposes or functions, such as medic, shooter, and so on, when employed in a tactical game, police training, simply for game play, etc. The user equipment stores and provides user activity data and user status data of the user as part of enabling the user activities in the activity area.

While described herein in the context of physical training and gameplay, the disclosed architecture finds broader applicability to compliance issues facing many different industries. For example, in the medical industry, it can be critically important to identify when certain procedures are performed and performed properly. Thus, the user equipment, which can include a user vest and sensors, can be utilized for auditing compliance with performing specific procedures. For example, a laboratory technician wearing a suitably designed vest and/or uniform can be tracked as to movements and locations for handling chemicals, completing tasks, etc., that need to be performed in accordance with set requirements (e.g., certification, licensing, etc.). This also applies to medical personnel and duties thereof, and any other industry that requires strict compliance with procedures.

The disclosed architecture can also be applied to security and safety for children or students and employees in educational settings so that the whereabouts of each child/student/employee is known at any given moment in time as well as associated biometrics and general health status. For example, where a security breach has occurred, each employee can be audited for location and health status in the physical school environment, in realtime. Thus, any human not registered in the system will likely be the security problem.

It is to be understood that any description herein as to gameplay applies equally to training scenarios for training in any discipline, such as law enforcement, medical, security personnel, first responders, personal residence training, and so on.

This can be visualized on a display in realtime to quickly evaluate the ongoing situation for all employees and students. This capability also facilitates automated lookout of rooms to any human not registered for entrance. Thus, the security threat can be prohibited from entering or leaving a room, for example, or any other designed area. This capability can also identify the source of a threat such as a gunshot or loud noise, for example, direction from which the sound is coming, and initiate safety actions/protocols based on that identification. The educational building can then be used as a training environment for police, medics, firemen, teachers, etc., during times when school is not in session.

The disclosed architecture provides the same capabilities whether for a training operation or not. Signals can also be forwarded to remote systems (e.g., police, medical, fire, first responders, etc.) suitably designed to receive such “live feed” information to monitor any given situation whether for training or non-training (actual status).

The vest can provide the basis for a “headcount” in a staging area prior to or as part of the activity. Thus, if a player (participant) is missing, this can be made known, as well as if a player should not be in the staging area, or is improperly equipped for the given activity or activities for a session.

The activity area can be constructed to be reusable arena in that a floor can be constructed into which walls, barriers, and obstacles can be inserted (e.g., bolted) and moved around for different scenarios. Additionally, the floor can be a false floor in which cabling and other items are placed to facilitate arena setup and activities. It is within contemplation of the disclosed architecture that a dropped ceiling (and/or the floor) can also be utilized for wiring, to locate cameras, audio pickups, sensors, gas systems such as smoke machines, lighting, sirens, audio, sounds, fog machines, rain machines, and the like, as desired. This can include wireless access points for wireless communications over a network for data, voice, and other realtime data, rather than direct voice communications via PTT (push-to-talk) devices, for example.

The DAC system can be employed in communication (wired and/or wireless) with the sensor system and the user equipment to process received sensor data, compute activity information, user information, and communicate activity parameters to the activity area and users. The DAC system can comprise a network (e.g., mesh, autonomous, etc.) that connects to the activity environment for various purposes. In one implementation, the sensor system utilizes RFID (radio frequency identification) technology for the user equipment and the sensors located throughout the activity area. As users pass certain sensors (e.g., RFID readers) in the activity area, the RFID tag data stored as part of the user equipment is read, and communicated to the DAC system. Thus, user location throughout the activity area can be tracked as well as other user data written into the RFID tag as the desired locations and times.

A database can be part of the DAC system or separate from the DAC system, that enables realtime parameter changes during arena activities. Thus, as activities progress, the administrator/supervisor can change any given situation, on-the-fly, at the user activities are occurring. A relational database provides the capability to select and change activity parameters and situations during on-going play (user activities). Keys can be changed dynamically in a relational database, such as for table rows, without locking players out to make the changes.

In the disclosed architecture, the database is the “smart” device, and all other systems, players, are the “dummy” devices. Thus, changes to the database are propagated into the activity set in realtime, as soon as the change is saved to the database system, or in accordance with activation settings for the given change(s). This is contrary to the existing the notion where, for example, a peripheral device such as a printer is the “smart” device and only interacts when it detects the device with which it should be operating.

As applied to user games in physical geographical areas of activity, an interactive environment and architecture is disclosed in which a game area or arena can be configured for physical interaction of players (users) to facilitate game play. The game environment can be a physical walled or non-walled area with or without a ceiling or overhanging structure. In other words, the game environment simply utilizes points of detection by which players can be detected and information received and/or exchanged. The points of detection are endpoints or nodes of a network that send (receive) information to (from) the game computing architecture to provide realtime game status information to all players and observers, whether an active player, temporarily inactive player, users who are observing play while viewing the game environment and/or the individual players (via in-game display devices of each player).

It is within contemplation of the disclosed architecture that observers (e.g., a supervisor and/or non-supervisor) and players can be provided a perception (e.g., view, audio and/or video) that a specific other player(s) perceives. Thus, an observer can selectively engage (e.g., switch, software button, etc.) a specific player to interact (e.g., audibly) with the player during play or as an inactive status (“on the sidelines”), or to simply observe tactics and game play of the specific player, as the specific player perceives the game play and game environment. This can be enabled using player cameras and microphones that provide video and audio signals via the many sensors that can be employed in the architecture, as part of the game, for example.

The architecture comprises realtime game data acquisition and status update so that users are readily apprised of changes during game play. Accordingly, player tactics can also be adjusted to improve user and/or team advantages over opposing users and/or teams.

The interactive game environment can include a network of detection devices (e.g., a mesh network—each node captures and sends its own captured data, but can also serve as a relay or repeater for other nodes) suitably installed, configured, and networked (wired and/or wirelessly) that detect at least the nearby presence of a user operating in the game environment. The detection technology can include, but is not limited to, radio frequency identification (RFID), and geographic location (geolocation) technologies that employ geographical coordinates (latitude/longitude) such as GPS (global positioning system), and triangulation technology (e.g., wireless signal strength, audio signal detection, etc.) that enable the identification of the physical location of a player in the game environment.

Radio frequency identification is a wireless technology that employs active and/or passive tags for automatically obtaining information of and identifying a tagged object (RFID chip mounted thereon or therein).

Additionally, each user is outfitted with a personal game system that enables play according to the environment and architecture capabilities. The personal game system employs the hardware/software that facilitates the game play using some or all of the architecture capabilities.

Following is a general description of the disclosed environment and architecture in terms of using RFID tags to track player location and capabilities (e.g. ammunition status, medical status, play (or participation) status, etc.). However, it is to be understood that other location identification and short-range communications technologies can be utilized to facilitate game play, information tracking, and status updates. For example, detection of a user relative to a location in the game environment (activity area) can be detected using sonic sensors, infrared detection technology, etc., and information communications can be employed using a short-range technology such as Bluetooth, near-field communications (NFC), and the like). The game play includes not only users, but also devices such as a variety of suitable weapons (for fighter players), medical kits (for medic players, if desired), communications equipment (for each player and/or communications players), and so on.

Accordingly, information such as device integration and allocation is known and processed (e.g., continually, on-demand, etc.), device parameters are known and processed (e.g., continually, on-demand, etc.), user integration and allocation is known and processed (e.g., continually, on-demand, etc.), and user parameters are known and processed (e.g., continually, on-demand, etc.).

Each device and user is defined, and each user may be assigned to devices and roles. The status (“state of being”) of each user (e.g., player, observer, sidelined/medically incapacitated or partially incapacitated user until spawn) and each device, are tracked and processed.

Triggers and events are defined and assigned to a status associated with a user and/or a device. The incoming status from an integrated device and user can be processed in realtime (processed in the timespan that the actual event is occurring). Incoming statuses (status updates) can be matched with current statuses assigned to devices and users. Activities and events can be activated through triggers associated with defined statuses that match the incoming (updated) statuses. Moreover, devices and users can be updated in accordance with activated activities and events and any changes thereto.

The play environment and architecture digital network comprises a datastore (e.g., a database, such as a relational database) that is used to configure, store, and update player information, device information, player and device statuses, activity parameters, triggers, and events. The datastore also stores and initiates all triggers and events within the interactive network.

The interactive environment is defined as the overall area covered by the mesh network of sensors and detectors (e.g., RFID readers/writers). Tags are defined as RFID tags attached to devices, objects in the play environment (not a device or a user), and users, which transmit to the mesh network of RFID readers. A status (“state of being”) can be defined as a vector of triaxial coordinates (x, y, z), for example, for physical location, proximity (to an entity such as another user, device, and/or play environment object), direction (or heading) of any object, object angle, device, and/or user that is tagged by an RFID tag.

A data point is defined as data read at a point in time as associated with an object, device, and/or user that has been tagged to be read relative to (e.g., within) the interactive play environment. A device is defined as any piece of equipment used by the user that can be operated, such as a weapon, communications pack (e.g., radio set), medical pack, etc. An object is as any piece of equipment used by the end user that is a dummy device (primarily, a receive-only device). A user is any person that operates or uses any device within the network of the RFID readers that track all the tags (of users, devices, objects).

Triggers are sets of predetermined criteria to be met by the status of a device and user in relation to another device and another user. For example, a rule defined for play processing as a trigger can be “when User A enters within three feet of Object A and operates at or within that distance for at least ten seconds, then initiate the predetermined event”. Events are any activity within the game environment (activity area) that is to be initiated once the criteria of a trigger are met.

A game session encompasses all user activity in a game environment, and has a start time and an end time. The start time can be initiated by a preset start time (e.g., play begins at 8 AM), or triggered by a user being detected near a play environment object (e.g., RFID reader). The stop time can be a preset stop time (all play stops at 9 AM or the session ends in one hour from the start time), or triggered when only one player remains or is detected in the play environment, or based on some other criteria.

A player session can be the same duration or shorter duration than the game session. A player session encompasses all activity of a given user, which can include when the given user is detected in the game environment, and when the user leaves the game without an expectation of returning to the current game session. Data sets are the collection of at least the interactions of a user with data points, activities initiated, and numerical values assigned in accordance to such.

A physical location (e.g., warehouse, room, building, etc.) can be converted into an interactive game environment by installing RFID readers and/or other suitable sensing devices throughout the physical game environment. Users, devices, and objects in the interactive environment will have RFID tags attached thereto to transmit the tagged entity (user, object, device) status (e.g., triaxial coordinate location, direction (or heading), and angle (vertical variation)). An example of angle is that a gun is pointed upward or downward along a vertical plane that is orthogonal to the horizontal plane. Alphanumeric identifiers can be assigned to the devices, objects, and users that will be used in the interactive environment.

The datastore can be used to define (either preset or manually entered) the criteria for the triggers and assigns the triggers to events that are preset or manually entered. As users navigate through the interactive play environment (the activity area), the user location, heading, and angle are monitored (e.g., continuously, frequently, etc.). Once the criteria for a trigger are met, then an associated event is initiated. The system then executes the steps associated with enabling that particular event. These initiated steps can include activating devices, deactivating devices, updating a scoring system, changing the capabilities of a device, changing the activity parameters, positively or negatively biasing play of a user or team, etc.

When a session is completed data sets are collected, stored, and used to update devices, objects, user capabilities for the additional rounds, and for other suitable purposes. In such instances, as previously described, the database drives at least the play, activity parameters, and conditions in the activity area. Changes to the database are immediately processed and translated into actions in the activity area, such as communicating information to users, changing conditions of play, and so on.

The disclosed architecture facilitates the training of police and other law enforcement entities. For example, the architecture tracks the triaxial (x, y, and z coordinates) location, and direction (heading) an officer is facing (the officer's “state of being” to status), for example. The officer's status record in the database has attached to it one or more triggers that activate events, activities, and experiences. These triggers can be activated by the actions of the officer (player or user). Potential relationships between the officer, objects of other officers, attackers, and rooms can be established, and that when established, activates the triggers. The relationships are defined as the correlation between the status of any two tagged entities such as person, object, and/or room.

Criteria are established, and once met, the trigger is activated. This is accomplished, in one implementation, by developing a decision tree that comprises actions that are performed once when each respective decision is made. For example, with respect to a quick look when searching a room, the decision is to quickly visually secure the room. The action is to have the officer stop and face the door of the room for a minimum amount of time. This is accomplished by the system tracking the location of the officer (e.g., in realtime). When the officer stops at the door of the room and turns to look, the system notes the direction the officer is facing.

The system uses the location of each tagged entity (e.g., person, object, device) to compute the distance the tagged entity is from other tagged entities at any given point in time. This information is used to create relationships with all tagged entities (e.g., objects, people and devices).

In a first example, consider that an officer steps into a hallway and bypasses a first room, making way to a room at the end of the hallway, and an attacker steps out of the first room and into the hallway behind the officer. The system recognizes that the attacker is in the same room (or hallway) as the officer, calculates the distance between the officer and the attacker, and if the officer is or is not facing the attacker. A timer can also be activated. As the attacker approaches the officer, the distance from the attacker to the officer is logged. Once the officer turns and engages the attacker, the time is noted, but not stopped. If the attacker is dispatched, the timer is then stopped and the distance is logged.

The system can then report that the attacker stepped behind the officer from a distance of x feet (e.g., thirty-five feet). Over the course of y time (e.g., one minute and thirty-six seconds), the attacker closed the distance to the officer to approximately z feet (e.g., five). The officer then turned, engaged, and dispatched the attacker (e.g., which is clocked at another one minute to completion of the dispatch). From this data, can be determined that it took the officer one minute and thirty-six seconds to realize that the attacker was behind him and then to react. Additionally, in that time, the attacker was able to move thirty feet closer to the officer. For this data, the officer's awareness and reaction time can be measured. The activity area and users can be captured and visualized/presented to a supervisory display in 3D, as well, for a more realistic perception of activities.

In another example, an officer is tracked during room sweeps. As the officer navigates through the building, the officer-to-room relationships are tracked. A decision tree can be used to determine whether and which events are to be triggered. For example, the decision tree may indicate that rooms one through four need to be checked in order and with a precursory search time (e.g., a minimum of a seven-second stop to look through the room such as by looking in). If the officer skips a room, then an event can be triggered such as the sound of a baby or child crying in the missed room, in response to entering the next room in the sequence.

In yet another example, if an officer enters a room and an attacker is present, then a timer starts and the distance between the two entities can also be logged. As the officer and the attacker engage in simulated combat such as with weapons, the system tracks the changing distance between them and maintains the timer. When the simulated combat is finished (e.g., the attacker is “killed”) the system logs the time and distances maintained in the officer's engagement table stored in the data store.

The game architecture can support many different games. For example, game modes include, but are not limited to, Assassin, Capture the Flag, Capture the Flag box (Medic mode), Marines versus Rebels, Sleeper Cell, Hostage Rescue, Horror, Camp, and Gauntlet.

In Assassin, each hunter player is assigned a targeted player (a mark) to hunt down and terminate from play. The location of the target player is displayed on a display device (e.g., a wrist display) of the hunter player. For example, if the hunter player is designated as an assassin, the only other player information shown on the assassin's wrist display is the target player. The location can be displayed immediately, or with some configured delay (e.g., five seconds). Each player is a hunter player as well as a targeted player. When a hunter player has eliminated their assigned targeted, the hunter player is assigned a new target player, when one comes available.

In Capture the Flag, a box is placed having a realtime locating tag attached is placed in a room. The system (that includes the capabilities of a realtime locating system) logs the x-y coordinates of the box. When the realtime locating system reads that a player of a team (and having a team color) is within a predefined distance (proximity distance as part of a proximity sensing configuration) of the box (e.g., six feet), the player “tags the box”, a timer (e.g., fifteen second) associated with the box (e.g., on the box) is initiated by the system and the box begins flashing the color of the team of the player that triggered the proximity alarm. Each player on the team that steps within the proximity distance of the box during the time set for the timer will be logged as doing so. Each player that tags the box reduces the timer countdown by a number. For example, decrementing from twenty to zero by ones can be increased to decrementing by twos, and so on. When the timer has counted down to zero, the flashing state associated with the box changes to a constant “on” state.

If a player of the opposing team tags the box during the timer countdown, the timer reverses and begins counting up to twenty, and when twenty is reached, restarts the count down for the opposing team. However, if two opposing team members tag the box substantially concurrently (within a predetermined time setting, e.g., two seconds), the timer can be controlled to freeze (stop working) until some intervention is employed to enable normal resumption of timer operation.

When a hunter player terminates two target players (before the hunter player is terminated) the hunter player is given the capability to activate a bonus display of bonus options (e.g., a UAV (unmanned aerial vehicle), also commonly referred to as a “drone”) using a wrist display. The bonuses can be in several different forms: a drone bonus (e.g., one point) for a kill streak (one or more kills, where a kill is play terminations of opposing user players), an ammunition (“ammo”) bonus (e.g., two points) for a depot capture streak (one or more captures of an ammo depot), an Emp (or (CTF) capture the flag)) bonus (e.g., four points) for a CTF streak (one or more captures of the opposing team's flag), a combination of streaks (e.g., two or more of the prior streaks), etc. If the player uses a bonus due to a successfully completed series of events or tasks (a “streak”), the streak is reset. The types of streaks include, but are not limited to, a “kill” streak where the hunter player terminates target players a minimum number (e.g., two) of times before being terminated by an opposing player. A flag capture streak is the minimum number of times a team player captures an opposing team flag before the team player is himself terminated. An ammo depot streak is the minimum number of times a player accesses the depot before being terminated.

Along with a streak are associated bonuses. Streak bonuses include but are not limited to a kill streak bonus, a player is provided the bonus of viewing the location of players on opposing teams via their wrist display for a predetermined amount of time (e.g., five seconds). An ammunition depot streak and consecutive kill streak enable the player a bonus of selecting UAV or moving ammunition depot to reload the ammunition of all team members one time where the team members are within a predetermined distance (e.g., six feet) of the bonus player. In one example implementation, the ammunition depot streak can be a value of one and the consecutive kill streak can be a value of two. A flag capture streak, longer kill streak, and ammo reload steaks enable the player bonus of UAV, moving the ammo depot, or EMP (electromagnetic pulse)(which disables the opposing player wrist display one instance for a predetermined amount of time (e.g., five seconds)).

In the Capture the Flag box (Medic Mode) game, only players with the medic class as an identifier (ID) stored in the RFID tag can activate the medic box. After a medic captures a flag, the medic box location then becomes a re-spawn point for the team players of which the medic is a member. In other words, the medic box can only be a re-spawn point for the teammates of the medic that activated the box. The medic player then receives a predetermined number of points for activating the medic box. If a medic from an opposing team tags the medic box, the medic box will then only work for the team of the medic that tagged the box later in time.

In the Marines versus Rebels game, three teams participate—Marines (e.g., six players) compete against two warring rebel factions (e.g., eight players each). As part of gameplay, the Marines are required to dominate or control (“hold down”) an area of the game environment for a specific amount of time (e.g., fifteen minutes). The two warring rebel factions fight to gain control of the area under control of the Marines. Only one team can have control of the area when the time is completed.

The rebel teams are required to accomplish four objectives to win: hack an entranceway to advance into and through the area, hack the Marine communication lines to disable Marine re-spawn, hack the Marine ammunition to stop the Marines from reloading, and capture the Marine base.

Hacking an entranceway involves more than one player (e.g., two) placing the back of their wrist display against two sections of the wall, which each section incorporates an RFID reader. The readers read the corresponding RFID tags of the player wrist displays (e.g., in or on the back of the display). In response, a puzzle to be solved is presented to each player on the player displays. Once solved by the players, the players are allowed entrance into the area. However, both players must successfully solve the puzzle in order for either or both players to enter.

Hacking the Marine communication lines is similar to the above entranceway; however, only one player is needed to accomplish this goal. The player(s) hacking the lines cannot be the same players who hacked the entranceway.

Hacking the Marine ammunition is accomplished according to the same rules as for either hacking the entranceway or hacking the communication lines.

Capturing the Marine base can be accomplished by standing within a predetermined distance (e.g., six feet) of an RFID reader enabled box in the Marine base. In contrast, a rebel must stand according to the predetermined distance for a greater amount of time (e.g., ten seconds). Ammunition boxes, medic/medical supplies, and re-spawn areas are presented on the displays.

The Sleeper Cell game comprises four teams for four players each. Three players of the four teams are selected to “go rogue” (act on one's own behavior and not as a team). The selection criteria can be the three highest scoring players of the four teams, which selection is initiated a predetermined time (e.g., ten minutes) after the game starts. All players are able to see ammunition boxes, medic boxes, re-spawn areas and fellow teammates on a map via the player wrist displays. When the three rogue players are selected, each rogue player is notified via a message on the display that they are now designated as rogue players. The three rogue players then compose a fifth team, and the rogue players will then see the other rogue players.

In the Hostage Rescue game, a group of players are tasked with working their way through several sections of the arena (or area) to rescue a hostage and bring that hostage back to a safety area. The rescue team is allowed to see a layout of the arena, location of ammunition boxes, medical kits, and re-spawn areas, on their wrist displays.

One player of the rescue team is designated as door breacher (proficient at breaching doors). Several doors in the area are locked and will need to be breached. In order to breach the door, the breacher player will need to place the back of their wrist display against the door lock for a predetermined amount of time (e.g., five seconds) for reading by an RFID reader. Once the system has recognized (read) that the door breacher player is within the proper distance of the door lock, a timer will begin. Once the time counts down to zero, an explosive sound will play and the door will unlock allowing entry by the team. The hostage will need to be escorted back to the beginning area to win the game.

In the Horror game, players need to navigate a building complex (e.g., apartment) to investigate a disturbance. When entering the rooms, the rooms are dark and bloody. While making way through the rooms, various electronic items will power on and off, lights will flicker, and spring loaded doors will pop open. This can be enabled laser sensors, sonic sensors, or the like, for example. After the players reach the end room, they will need to fight their way back to the starting point. As the players return to the starting point, the lights will go out and other forms of light are relied upon (e.g., flashlights attached to their guns) to see the way back.

In the Camp game, two teams, each with a team leader, go on a two day, three night camping trip in actual physical outside conditions to achieve objectives. Each team leader has an RF receiver in their vest (personal game system). Additionally, each team leader will have a device (e.g., a device designed according to the Raspberry Pi™ Foundation) on which to run the game system. (A Raspberry Pi is a small single-board computer (SBC) that comprises memory, video I/O, audio output, central processor and graphic processor, input/output functionality, serial bus interfaces (e.g., USB-universal serial bus), onboard power, software operating system, and network interface (e.g., Ethernet)). Players can use a wrist display to track their location and show objectives.

In the Gauntlet game, final scoring is contingent upon the configuration of the gauntlet. Competition ranges from 1-on-1 to any combination through 3-on-3 (e.g., 1-on-2, 2-on-3, etc.) and occurs down a path or route (e.g., hallways) along which trip sensors are placed. Trip sensors (e.g., laser beams as trip wires) can be configured to be navigated around/through. The entire gauntlet can be timed so that the player/team with lowest time taken to navigate the gauntlet, wins. For each sensor triggered, a time penalty (e.g., two seconds) is added to the clock. Targets can be located above the doorways and in other desired locations, which players will need to shoot to unlock the doors or perform other functions. It can be the case that instead of unlocking the door, it will enable the player to unlock/or lock it (e.g., a sniper teammate can shoot targets above doors to enable teammates to unlock the door). The reverse can be configured as well, where a sniper of one team can shoot a target(s) on the other side of the door to lock it. Players need to unlock a “safe” via RFID to get an object that will stop the timer.

In another implementation, navigation of the gauntlet can be limited to a maximum time such that according to a preset time condition (e.g., no more than five minutes to run the gauntlet) failure to navigate the gauntlet is a loss.

Player scoring as well as other information can be stored and analyzed. The scores achieved by a player during gameplay can be saved and added to an overall score. When the player score reaches a specific value, the system can enhance the player in one or more of several areas: player health (medical health points or credits for extended game play), damage (the capability to cause increased damage effects for actions), and hacking speed (the speed at which to achieve a goal). For example when the player's overall score from several game sessions reaches an accumulated value (e.g., ten thousand), the player's base health can be increased a corresponding health value (e.g., one point). Similarly, when reaching a different accumulated value (e.g., twenty thousand), the player's base damage effect can be increased by a corresponding damage value (e.g., one point), etc.

The wrist display can be provided for each player via which to provide ongoing game information such as opponents, scores, time, statistics, goals to be achieved, and so on. This can be a touch screen display as part of the SBC device to facilitate more expedient and efficient play by touch rather than physical key or virtual keyboard, although that can be implemented where desired. Alternatively, the wrist display communicates wired or wirelessly to the SBC device. The wrist display enables the player to view in-game statistics as well as a map of the arena being played. Additionally, the realtime location of the player and/or player team mates can also be shown. Moreover, the wrist display enables players to activate the bonuses obtained from earned streaks.

The personal game system includes a vest comprising vibrating motors enabled by the sensors to indicate, among other things, where the player was shot, how badly the player is injured, etc., as indicated to the player by a sequence of vibratory signals (e.g., a series of two distinct and separate vibrations can indicate the user is moderately injured and can return to gameplay once “repaired” or treated by a medic or other player. The vest can employ an RFID reader in which a player can then revive the injured player with a paddle that has an RFID tag in it, which simulates a defibrillator device that restarts the heart.

In an alternative implementation, the aforementioned vest with sensors can be complemented or replaced with a motion capture suit. The motion capture suit uses inertia measurement units to calculate full body position; however, the motion capture suit can still use the force feedback motors.

Each player can choose an alias (pseudo name) with which to be identified in the game. This name is logged and associated with all statistics of the player. Paying members (or subscribers) can be issued an identity card and have their nickname locked into the system so no one else can use it as well as retain all statistics on file for as long as the player is a subscribing member. The alias (or nickname) can be assigned to (associated with) the wrist display and gun system. Assigned statistics can be streamed from gun system to player. The statistics can include, but are not limited to, shots fired, number of times they have been hit, the number of times they have hit the target (sensor), the number of times they have missed the target (sensor), and which sensor was hit.

When player is assigned a weapon, vest, and wrist display, and other possible assignable game gear, the player scans their subscriber card, which name is then displayed on the wrist display. By placing their wrist display near (or in contact with) a black square under a check-in kiosk computer screen, the players name, class, and team color are coded into the game system for the specific game. Messages can be communicated to players via the wrist display as text or graphics on the display and/or as audio output to the player.

Only a specific target player can be selected on a player wrist display that they are to shoot (or eliminate from further play). If the previously-target player has been removed from play, a new target player can be automatically presented or selected. When a hunter player terminates a predetermined number of target players before being eliminated, the hunter player will receive bonus points (e.g., twenty). When a player captures a flag a predetermined number of times (e.g., four) in a round, the player will receive bonus points (e.g., twenty). When a player activates a medical station a predetermined number of times (e.g., four) in a round, they receive bonus points (e.g., twenty). When a player breaches a predetermined number of doors or entranceways doors in a round, they receive bonus points (e.g., twenty).

In preparation for entering a game, the player's name is entered into the system as having a fixed number (e.g., three) games available for play. The subscribing player is issued a player card with a gamer tag, and the player members have “dog tags” with an affixed or embedded RFID tag. The player goes to a check-in kiosk which displays the maps and the game modes available. The player can click on map, and a text box will appear detailing the map and the game mode for that map.

Players can scan the card and/or dog tag and their gamer tag is interpreted and presented at the top of the kiosk screen with an icon for each game to which the player has subscribed (e.g., paid). The player then drags one of the icons onto the map of their choice. A box appears prompting the player to decide if they want to join the next game. When the game starts, the system obtains the names of all the players associated with that game and enters the names into the system. Members can purchase games online for their client devices and go to the check-in kiosks. Certain games can free to entice increased participation, if desired. For example, the Gauntlet game can be free for players that have purchased three games or more. Alternatively, subscribing members can obtain the game free after buying two or more other games.

The arena can comprise various pieces of RFID reader equipment such that the RTLS reads that the player is within a proximity distance from a required game object. It is to be understood that both active and passive RFID devices can be employed.

As indicated herein, the disclosed game architecture can be utilized for the training purposes, such as for law enforcement officers and military personnel, for example. All statistics and data streaming from the player vests can be stored, such as for heart rate and other biometrics. Additionally, all movement of a player, as logged by the architecture positioning system, can be stored for review and analysis.

Certifications/qualifications can also be based on passing some or all of the situations/challenges/games selected for meeting such requirements. The certifications can be recorded on a per officer basis and adjusted for different performance requirements of the individual, for example. The stored data also facilitates the scheduling of usage times of a facility designed for the game and/or training purposes. The scheduling can be accomplished using standard online applications interfaces via a browser, for example. Moreover, map designs and requests can be made and selected by departments and organizations for use during their scheduled game and training periods.

The personal game system includes the capability to connect (wired or wirelessly) a game tool such as a weapon or other suitable game play device using a wired communications tether and/or wireless short-range communication technology (e.g., Bluetooth™). Thus, if a shooting device (e.g., a rifle, handgun, etc.) is being used to engage targets (e.g., other players, inanimate targets, etc.), the shooting device communicates with the personal game system (e.g., as a vest and/or other wearable clothing for other parts of the body such as waist, legs, hips, calves, ankles, etc.) such that, for example, the pull of the trigger is interpreted as a signal to the personal game system that a shot has been fired. Accordingly, other related information can be tracked such as the amount of ammunition expended, reloading actions, and so on.

The equipment capabilities such as for weapons, for example, are programmable (in contrast to conventional systems that are typically hardcoded) and changeable according to software configurations. For example, a circuit board with hardware and software onboard can be interfaced to an existing and suitable type of “toy” gun to enable the gun to be used in physical activities of the activity area. Consider that a sturdy rifle (e.g., strong plastic) can be modified to include the circuit board and a laser subsystem such that the laser subsystem can activate the laser alongside or through the barrel to engage targets having laser-sensitive detectors. Additionally, triggers pulls can be counted, onboard power source monitored, firing disabled entirely, and so on based on the onboard programming and/or commands received from the administrative system, for example. The recoil sensation can be adjusted as well for weapons to provide more realism to the user/participant. Thus, the gun/tool can be adapted to many different training/activity scenarios.

Following is a description of the software and hardware capabilities of one exemplary weapon, a game gun, which can be employed during game play. The game gun can be designed and constructed for rugged play, and in some instances, can be similar in weight, feel, and functionality as the real version of the gun. For example, the trigger pull of the game gun can be matched closely to the actual trigger pull of the real version of the gun. As another example, the weight of the game gun can be closely matched to the weight of the real version of the gun. Thus, where application of the disclosed architecture is to police training facilities, for example, the participant can experience as close as possible, many of the actual gun parameters during training or game play.

An exemplary game gun can components such as a laser diode that emits light signals detectable by a target sensor, a speaker for outputting audio signals (e.g., voice signals, status signals beeps, etc.), a display (e.g., LCD, LED, etc.), a reload button that when pressed performs a reload function for the gun, a firing type button that enables semi-automatic firing or full automatic firing, a trigger button that enables firing of the gun (to emit the laser signals), a communications subsystem for wireless (an antenna) communications and/or wired communications, and an RFID subsystem (e.g., an RFID reader, passive or active RFID chip, etc.).

The personal game system (e.g., a vest) can include an RFID reader/writer, a force feedback motor for generating vibratory signals sensed by the user, sensor grouping in an area of the vest, and an RF antenna. Participants can be outfitted with arm/leg sensors subsystems such as arm pads/cuffs, leg pads/cuffs that when activated by a signal, indicate to the user and system that an event has occurred. In one example, a sensor string(s) (e.g., serial, parallel) can be affixed along an appendage of a user such that when “injured” and medical attention such as a tourniquet should be applied, and applied properly, applied pressure by a team participant can be monitored. The sensor string can be conductive magnetic bars that when two are brought into contact, complete a circuit. When the proper tourniquet pressure is applied to the sensor string, through layers of non-conductive vest material, the more pressure applied translates to increased electrical conduction in the sensor string, eventually competing a circuit which indicates to the DAC system the tourniquet has been properly applied, and other actions can be enabled, such as further play by the remedied player, further weapon action, increased medical points, etc.

In combination with the medical/injury aspect, the vest can comprise liquid packs (or “blood packs”) that release red liquid when the user is deemed to be injured. The user's biometrics can be monitored as additional information to determine the level of injury. Once the proper medical treatment has been applied, the liquid pack will be closed or stooped from releasing additional contents. The treatment time can be monitored from the time the injury occurred to when the injury was fixed.

This capability can be applied to other packs utilized for training purposes. For example, when “suiting up” for a mission, the user vest can track all the gear that should be used by a given player. Thus, if a medic should have in a medic pack, a tourniquet, but fails to obtain this item, this can be monitored. The same applies for ammunition, and other gear (e.g., armor, water, personal medic packs, etc.) designated for a particular scenario.

Stored data for the game gun can comprise data related to the gun not having any ammunition (e.g., magazine empty) in which case an audio signal is generated that is identifiable as indicating no more ammunition, the maximum capacity of the gun magazine (e.g., twenty rounds), an audio fire signal is generated that is identifiable as indicating the trigger was pulled, the maximum amount of reserve ammunition available, the action initiated to reload the reserve ammunition, the player level (e.g., the level of skill for a given play environment), the magazine count for the current number of magazines the player has, and a magazine identifier (ID), for example. Other data can be captured and stored as desired. Of example, if the user gun employs a camera, the video from the gun camera can be recorded and stored. Alternatively, a camera can be made operational as part of the personal game system and, recorded and stored from that perspective. In yet another example, the camera can be made operational as part of goggles or other eye wear the player may be wearing, and recorded/stored from that perspective.

The display can present the installed magazine capacity and capacities of the reserve ammunition/magazines at any point in time. The display can present other information as desired, such as team member identifiers (e.g., names, aliases), team members still in play (in contrast to those members who have been shot, and hence, deactivated from play or reduced in capability to play to represent wounded players), etc.

In one operation, when a player pulls the trigger of the weapon to fire, a check is made of the amount of ammunition available in the inserted magazine. If there is no ammunition, an empty audio signal is played to the player immediately ascertains there is no ammunition, and needs to reload. If there is ammunition, the pulse laser is activated once for each single round in the magazine and a fire audio signal is played so the player hears and knows the gun fired once. The ammunition count on the display is then updated (decremented) to account for the spent round. For a semi-automatic setting, this process repeats for each trigger pull. For a full-automatic setting, a single pull of the trigger results in a fire audio signal presented for each round fired, until the user stops the trigger pull, or the magazine runs empty of ammunition. The display continually updates the ammunition count as the rounds are fired, until empty, in which case, the empty audio signal is played.

The amount of (digital) ammunition available is a programmatically monitored/derived value according to various inputs such a trigger pulls, for example. In one implementation, the digital bullets are generated and tracked using a circuit board wired into a physical firing mechanism of a physical rifle or handgun. The circuit board comprises the desired components for inputs, outputs, communications, controller, and memory suitable for operating in the game and with all game functions.

The rifle/gun recoil and trigger tension are realized from the actual physical mechanics of the rifle or handgun. Once the trigger is pulled, the board checks for available ammunition. If there is ammunition, the firing mechanism is enabled. Once the firing mechanism is enabled, the board registers an action that fires a solid state laser. The laser is in alignment with the gun/rifle barrel, and thus, is directed in accordance with the player's aim. The laser impacts a target (e.g., opposing player, other game items, etc.) and the back scatter of the laser light is detected and/or the laser light impacts light-sensitive devices of an opposing team, opposing player, game items, etc. Such optical contacts can be detected on the target and processed accordingly. The light-sensitive devices include, but are not limited to, light detector electronics, a lens that receives the light and focuses the received light to an associated light sensor, which sensor sends signals to a user equipment control system, for further processing, and so on.

In order to reload reserve ammunition, a command is sent from the gun to the central server to reload the reserve ammunition. The command can include the gun identifier (ID) and reload-reserve-ammunition command. The server than processes the command to bring the reserve ammunition to the maximum allowable capacity. This can include loading one reserve magazine or all the reserve magazines.

When reloading a magazine, a reload button is selected (e.g., pressed) on the gun. A check is then performed to determine the play level of the user. If the users is on the same play level (has not progressed to the next level of play), the current magazine count is subtracted from the maximum magazine capacity, and this number is then added to the current magazine count. If the user is entering a high level of play, this reload magazine function is ended.

With respect to a physical magazine reload, initially, the magazine ID and the magazine are set to a value of one. The magazine is then physically ejected (in hand) by the player. The player holds the empty magazine (e.g., the top loading end of the magazine) against the personal game system (e.g., a vest), and the RFID reader of the vest reads the magazine RFID chip. If the magazine ID in the chip is a value of one, the RFID writer in the vest rewrites the one value to a two value. Subsequently, a magazine vibratory motor of the vest activates a pattern of three consecutive vibrations of one-second duration each. If the magazine ID is a value of two, the RFID writer in the vest rewrites the two-value to a one-value. Subsequently, a magazine vibratory motor of the vest activates a pattern of three consecutive times of one-second duration each to signal to the user that the reload has completed.

Once reloading has completed, the user inserts the magazine back into the fun. The gun subsystem(s) then check if the magazine ID of the inserted magazine matches the magazine ID expected by the gun. If they do not match, the process ends. If they do match, the magazine ammunition count is brought to full magazine capacity. The magazine ID is then changed to a secondary number value.

Following is a description of player interaction with an ammunition depot box, as well as death and spawning actions. The ammunition depot box includes an RFID reader, a radio frequency transmission module, a micro-computer board and colored indicators (e.g., six multi-color (red-green-blue) light emitting diodes (LEDs)).

Data stored and processed related to these action include, but are not limited to, team colors, gun ID, vest ID (of the personal game system), a death command, a spawn command, an initiate hack command, a reload reserve ammunition command, a box ID, a hack complete command, a death motor pattern, and a spawn motor pattern.

In operation, when the player enters into the communications proximity of an RFID reader (e.g., stationed in the play environment as part of the mesh network), the player vest information is read: the vest ID, the team color(s), and the gun ID. A check is then performed to determine if the team color matches the team color of the depot box. If not, the gun ID and the vest ID are retransmitted, with the addition of the box ID and the initiate hack command. If the team color matches the team color of the depot box, the gun ID and the vest ID are retransmitted, with the addition of the reload reserve ammunition command.

The hack completion interaction with the depot box includes receiving into the depot box the box ID, team color, gun ID and hack completion command, and in response thereto, lighting the appropriate RGB LED to match the team color, and then retransmit the gun ID with the reload reserve ammunition command.

The death (or elimination form competition) process can be as follows. The death process can be a gun disablement and/or a vest disablement. The gun disablement occurs when the gun ID and the death command are received, after which, some or all gun functions and/or activities are disabled until a spawn command is received. The spawn function re-inserts a player previously removed from play, back into play. Vest disablement comprises receiving the vest ID and a death command, after which a death motor vibratory pattern is generated for perception by the player (indicating the player has been terminated from future play unless spawned), and then the vest sensors and motors are disabled.

The spawn process can be as follows. The spawn process can be a gun reactivation and/or a vest reactivation. The gun reactivation occurs when the gun ID and the spawn command are received, after which, some or all gun functions and/or activities are reactivated. Vest reactivation comprises receiving the vest ID and a spawn command, after which the vest sensors and motors are reactivated (re-enabled) and a spawn motor vibratory pattern is generated for perception by the player (indicating the player can now participate in future play).

As examples, the death motor vibratory pattern can comprise a first thirty-second vibration at full power, followed by a second thirty-second vibration at full power, followed by a thirty-second pause, followed by two forty-five-second quarter-power vibrations, a thirty-second pause, a one-second half-power vibration, a ten-second pause, and a two-second vibration at half power. The spawn motor pattern can comprise a two-second vibration at quarter power, followed by a ten-second pause, a one-second vibration at half power, two forty-five second vibrations at three-quarter power each, another ten-second pause, and two thirty-second vibrations each at full power.

Many different models of weapons such as handguns, rifles, bows, crossbows, etc., can be employed for game play, and other real-world applications of the disclosed architecture such as for police training, security services training, and the like.

The environment and data system finds applicability to video game integration as well. Teams can each have a member, local or offsite, participating from a remote computing system as a commander, for example. A commander user interface (UI) can be presented the commander player and show the same or similar information as a wrist device display. Additionally, the commander UI provides the capability to unlock doors, reload ammunition, and hack. As the team progresses in points, more options can be made available for the commander. The same capabilities for streaks and bonuses can be applied. Any three of the same streak by the whole team and the commander receives the associated bonus.

The physical room (activity area) can be digitally recreated within the video game engine. The physical player activity sets can be used to recreate a virtual player (an avatar) within the game environment. The virtual player can replicate everything within the game environment that the physical player can do in the real-world physical environment. This same capability applies to all relevant gear. The weapon angle can be tracked so the system knows exactly where the weapon is pointing. When the weapon is fired, the game engine uses bullet physics algorithms to track the virtual bullet. If a virtual avatar of a physical player is struck or hit (bullet contact, weapon contact), then the physical player is notified via a force feedback device, such as a vibrating motor, in the general area of the hit.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

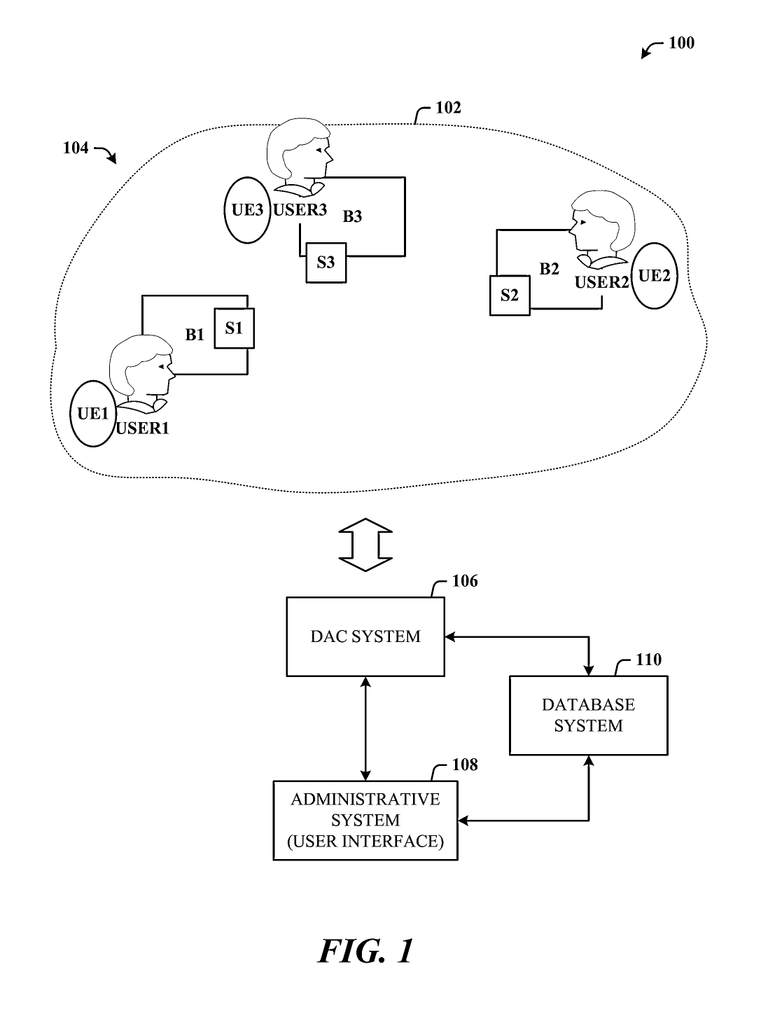

FIG. 1 illustrates a system 100 in accordance with the disclosed architecture. The system 100 comprises an activity area 102 in which user activities are conducted. The activity area 102 can comprise any number and arrangement of barriers or obstacles B1, B2, and B3. The activities are then conducted in and around these barriers. For example, the activity area 102 can be a building of one or more floors having rooms, stairwells, basements, rooftops, etc., that all can be considered as part of the activity area, and via which activities are conducted. The activity area 102 can also be configured in a nature setting of hills, trees, rivers, mountains, and so on, where activities can be conducted in such settings to consider not only these natural obstacles/barriers/challenges, but also environment conditions such as wind, hills, mountains, rain, cold, water, and so on. It can also be the case that the barriers/obstacles in the activity area 102 can be re-arranged as desired to construct new overall activity experiences and to present new challenges to the users.

As illustrated here, three users, User1, User2, and User3, are shown in the activity area. Each user has user equipment (UE) that facilitates training or gameplay. For example, the user equipment includes, but is not limited to, a vest, training tools (e.g., a weapon, medical pack, etc.), one or more sensors on the vest that when worn by the user can sense various types of data such as user biometrics (e.g., heart rate, body temperature, humidity, etc.), user speed and heading, medical status (e.g., wounded, “dead” (eliminated from further play)), microphone, camera, recorders, and so on.

Each barrier can also be outfitted with a barrier sensing system (S1, S2, S3) in wireless communication with one or more sensors or transmitters on the user equipment vest and/or training tools. Additionally, the barrier sensing systems can be configured as nodes of a wireless network that when detecting data of a user, that information is transmitted to a remote location such as a supervisory (administrative) system that processes and displays user and training data for at least all activities and status information of a given activity session.

For example, when a user (User1) is in communications range of the barrier (B1), the barrier sensing system (S1) can detect one or more sensors of the user equipment vest, such as simply that the user (User1) is currently at that location using an RFID reader system. Other information may be communicated from any given user and user equipment when in communications range of a barrier such as user voice communications from one user to another during activities, and user voice communications to and from a supervisor/administrator of the activity session.

Additionally, a user equipment tool UE3 (e.g., a weapon) of User3 can be designed with a hardware/software component that tracks usage and status at any given moment and stores this tool activity status information local to the tool. When in communications range of a barrier sensing system, some or all of this tool information can be communicated directly from the tool and/or indirectly through the user equipment vest hardware/software system.

Any amount of user data can be communicated to other users such as team members during activities in the activity area. This can be communicated in a peer-to-peer manner when two users are sufficiently close to enable short range wireless communications. This can alternatively be communicated up to the remote supervisory (administrative) system and back to another user. Still alternatively, this can be communicated via the barrier sensing systems to a user in sufficient communications range of a different barrier sensing system.

The overall sensor system can be defined to include all sensors that enable the desired activities associated with the activity area, such as sensors of a user equipment system, sensors of the barrier sensor systems, etc. For example, another sensing system can be an optical tripwire enabled between two objects in the activity area, using a detector diode and an electromagnetic radiation transmitter such as an optical transmitter. Once a user breaks the light signal, a trigger signal is sent indicating the tripwire has been triggered. Other sensors can include pressure plates on surfaces (e.g., a floor, ground, etc.) that send a signal based on a predetermined amount of applied pressure (e.g., a pressure threshold), and sonic sensors for distance and presence detection, and audio sensors for detecting sounds in a given area.

Accordingly, the system 100 can include a sensor system 104 dispersed in association with an activity area 102 in which user activities are conducted to sense user status and activity area information as part of the user activities in the activity area 102. The sensor system 104 comprises myriad types of sensors that can be employed, such as cameras to visually record activities in the area 102, microphones, pressure sensors for sensing horizontal (e.g., in the floor) and vertical (e.g., along walls) pressures, sonic sensors to detect distance, infrared, thermal vision, environmental sensors for humidity, temperature, elevation, etc., personal equipment sensor such as on a vest, biometric sensors to measure heart rate, body temperature, and so on. In other words, the sensor system 104 comprises all sensors employed in, around, above, and below, the activity area 102 as well on participants and gear being utilized.

User equipment can be employed as associated with a user performing the user activities in the activity area 102. The user equipment stores and provides user activity data of the user during the user activities in the activity area 102. A data acquisition and control (DAC) system 106 is in communication with the sensor system 104 and the user equipment to process received sensor data, compute activity information, and communicate activity parameters to the activity area.

The system 100 can also comprise an administrative (supervisory) system 108 that employs a user interface to enable the monitor of all data, activities, and participants in the activity area 102 as well as other participants in a staging area who are preparing to play or train.

A database system 110 (e.g., relational) can be provided to store some or all data and settings associated with activities before, during, and after the sessions, as well as to facilitate data analysis, authentication, security, remote access (e.g., observer, supervisory, participant, etc.), and reporting for all aspects of training and gameplay.

The administrative (or supervisory) system 108 interfaces to the database system 110 change parameters and/or configurations for a session or multiple overlapping sessions that may occur. The architecture is so deigned that a single parameter change to the session table or files in the database system 110 are immediately propagated to the DAC system 106 for implementation that can dynamically alter aspects of the ongoing training or gameplay. For example, if the supervisor overseeing session activities in the activity area 102 wants to immediately lock a door in the activity area, the supervisor can change an attribute or property of a “lock door” setting of a row in a relational database table that then is immediately processed and pushed to the DAC system 106 to lock the door associated with that row in the table.

Similarly, multi-row executions can be implemented where the supervisor has changed settings or attributes for multiple table row items, which are then immediately pushed to the DAC system for execution against sensors, user equipment of the users, weapons, communications systems (e.g., temporarily fail the communications of participant #3 while initiating a weapon jam of the nearest attacker, etc.).

It can be the case where session changes can be implemented via a matrix of all or most possible situations that can occur or be forced to occur during a session. Thus, the selection of a matrix cell is an intersection of two aspects that are then related and linked for execution during the session or immediately. Deselection of the cell then unlinks or disassociates the two parameters, actions, behaviors, etc., from being implemented in the training. Moreover, where a training facility is provided for lease for predetermined training exercises and structural configurations, templates can be provided for the organization seeking to use the facility such that many different scenarios can be mapped out for the training session or sessions and uploaded to the database system for implementation and configuration of the systems in preparation for training day. The database system 110 and/or DAC system 106 can also be used to store and retrieve videos, audio, communications, camera shots, etc., of all aspects of training for replay and review.

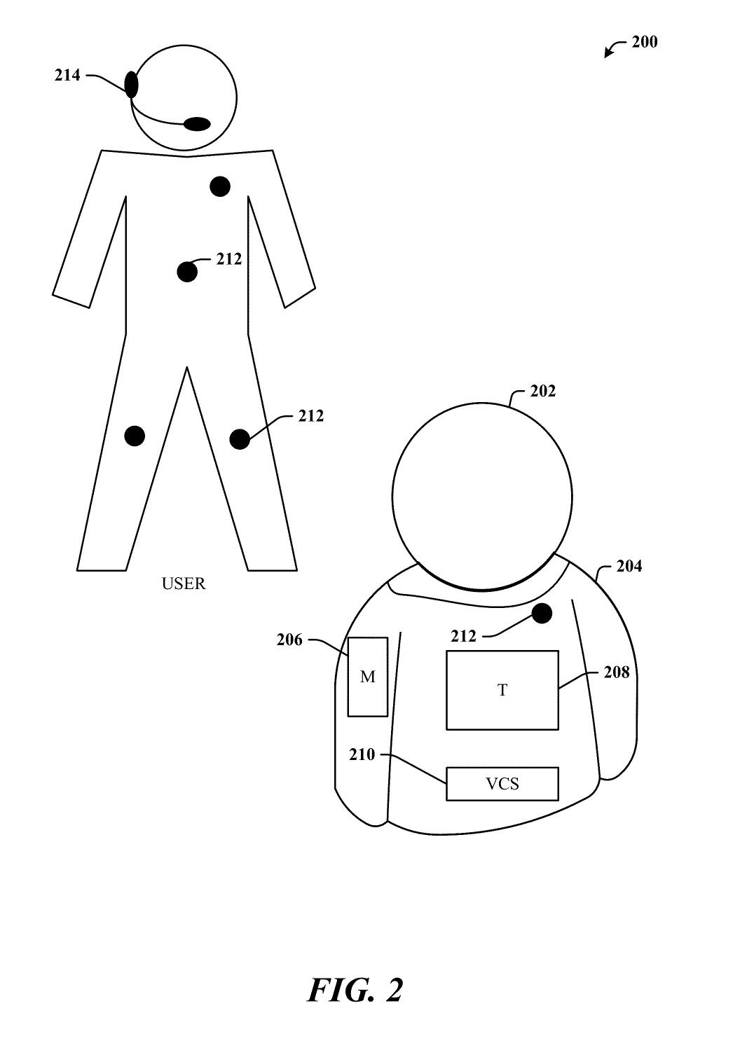

FIG. 2 illustrates an exemplary implementation of user equipment 200 in accordance with the disclosed architecture. The user equipment 200 (similar to the user equipment UE3 of User3 of FIG. 1) of a user 202 can comprise a sensor vest 204 having one or more sensors and sensor subsystems attached (e.g., via hook-and-loop, or Velcro™ technology, buttons, zippers, snaps, etc.) thereto. For example, the vest 204 can comprise a removable medical subsystem (M) 206 that tracks medical requirements for the user 202 during the activity session.

The disclosed architecture can employ metrics such as direction (heading) and proximity to determine access needs of the user. For example, if a medic (or other medical person, e.g., a doctor) is facing a user who is now a patient, and within a predetermined distance (e.g., five feet) and for a predetermined time duration (e.g., thirty seconds), then all medical requests made by the medic can be interpreted as a request for medical information of the user.

The medic can speak “let's see your arm x-rays”, and the architecture utilizes data such as location, direction, and proximity to compute which x-rays the medic desires. This methodology can also be applied to prescriptions for medications, for example. This type of activity automatically logs the medic into the user (patient) medical records. Other interactions can also be recorded for all activities and user responses in the activity area, and used later for data analysis of user actions and capabilities in specific activity area configurations and challenges.

Additionally, the vest 204 can comprise one or more removable target subsystems (T) 208 that are sensitive to a received targeting signal (e.g., laser light) from a source (e.g., opposing player or activity participant). For example, one of the target subsystems 208 can be attached to the vest 204 in a position over the upper abdomen of the user 202, and another target subsystem can be attached to the back of the vest 204 of the user 202, or over other areas of the body (e.g., legs, arms, helmet for the head, etc.).

Alternatively, or in combination therewith, an additional targeting subsystem (not shown) can be attached in other typically vulnerable locations of the abdomen of the user 202, such as on the sides or over the stomach area (lower abdomen), for example. The target subsystems 208 can connect to a vest control system (VCS) 210 that may be a localized data acquisition subsystem from which data and signals are communicated to the administrative system and/or other users vest user equipment. Alternatively, each sensor subsystem comprises the hardware/software to operate as a separate DAC and communications system. The user equipment can comprise a headset 214 for user bidirectional communications (audio and voice).

Vest biometric sensors 212 can be attached to the user body and/or be in sufficient contact with the user body via the vest 204 to provide the desired biometric data and signals. As depicted, other biometric sensors 212 can be applied to the desired locations to measure the desired parameters.

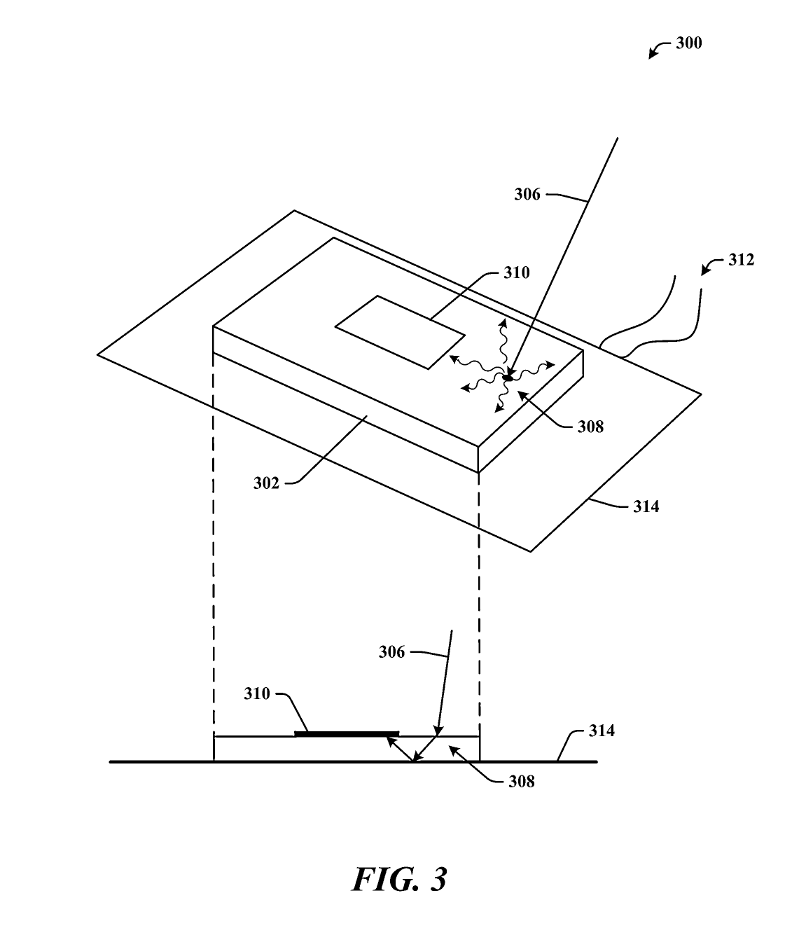

FIG. 3 illustrates a light sensing component 300 of an exemplary target subsystem 208. The light sensing component 300 generally comprises a suitably designed light dispersion element 302 (e.g., glass, Plexiglas™, etc.) into which light 304 (e.g., laser) is received and scattered 308 throughout to eventually impinge on a light (optic) sensor 310 which then outputs an electrical signal (via electrical leads 312) that indicates the user has been “hit”. In response to this “hit” the user may be eliminated entirely from further activities, or have a reduced medical reserve which enables further play but at greater risk of being eliminated from activities due to the reduced medical status. The dispersion element 302 can be mounted on a base 314, the back of which can comprise a material or mechanical arrangement (e.g., hook-and-loop fastener material) that enables securement of the sensing component 300 on the vest of other parts of the user. The base 314 can have a conducting surface (e.g., copper) such that the sensor 310 connects signals to the conducting surface for transmission on the leads 312.

The medical requirements of a user may be increased or replenished by communicating with a medical user or a medical depot, for example. The physical dimensions of the element 302 correlate to the accuracy needed to register a “hit” on the target. Since the element 302 serves as a “light funnel” to the sensor 304, the smaller the element 302, a more precise laser “shot” is required to contact the element 302 which is then more difficult to register a “hit”. Thus, the sensing component 300 can be made in various sizes for correspondingly different levels of expertise—a larger sensing component 300 for less experienced participants, and a smaller sensing component 300 for a more experienced participant. Moreover, the sensing component 300 can be attached (removable) to the vest at different locations and multiple sensing components 300 can be attached in different areas of the vest and/or participant, in general. Thus, where competition leagues (or training) are created, users can be classified at different levels of gameplay (training), and hence, ranked.

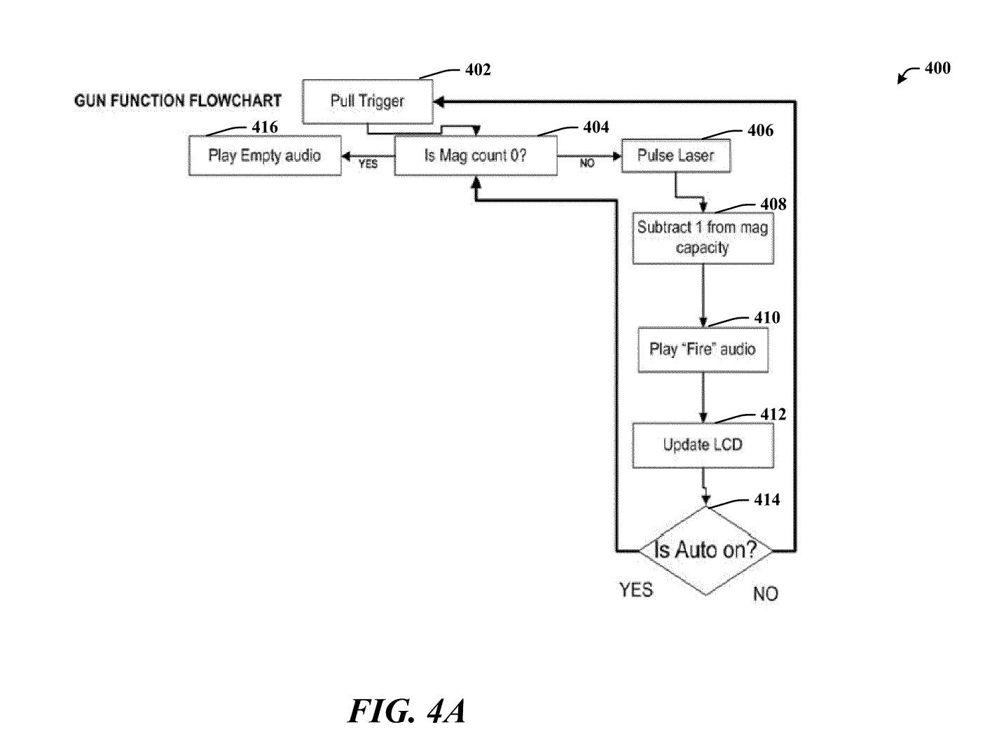

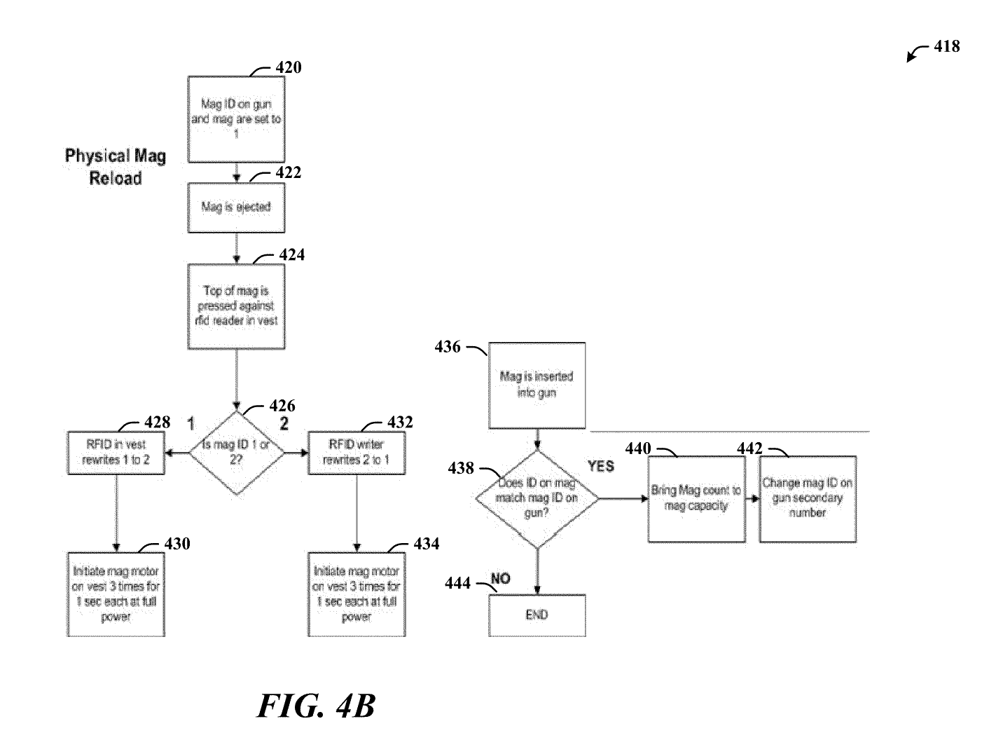

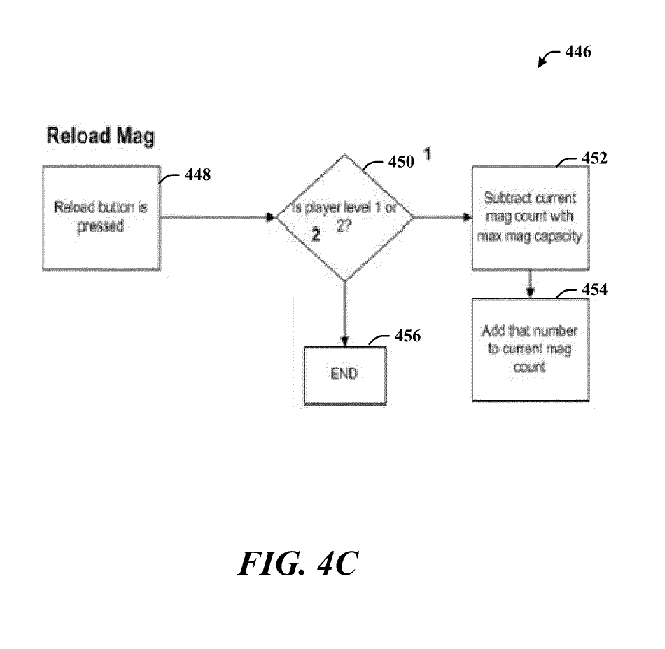

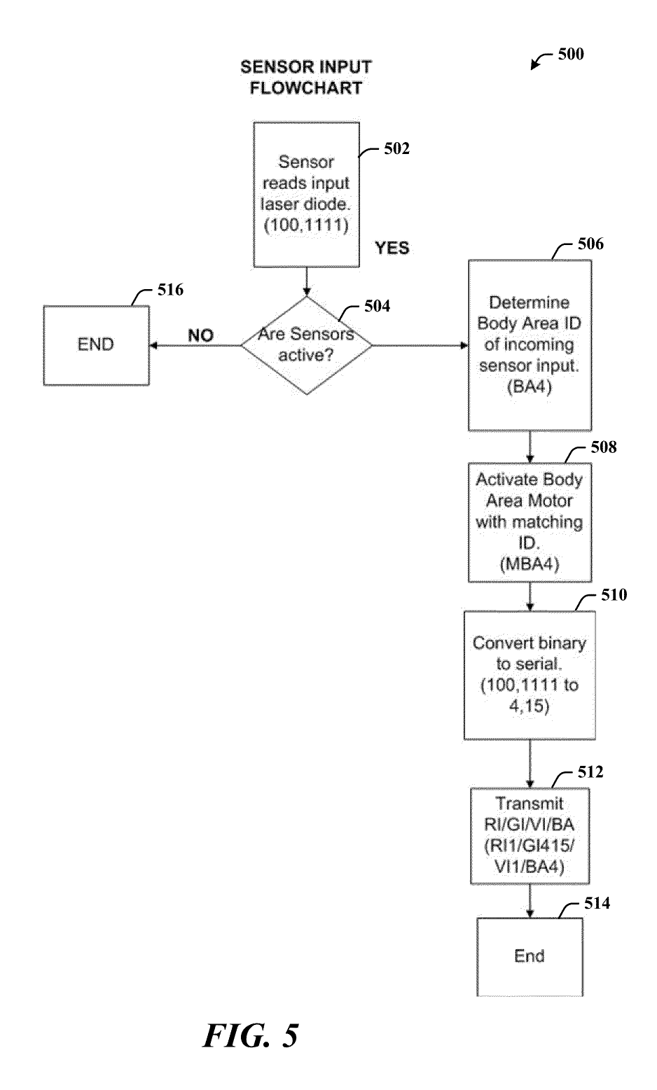

FIGS. 4-5 illustrate exemplary flowcharts for weapon function, weapon magazine ammunition replenishment, and sensor input. FIG. 4A illustrates a gun function flowchart 400. In this example flow, once the trigger is pulled, at 402, flow is to 404 where a magazine count (for available “ammunition”) is checked. If there is available ammunition (the magazine count is not zero), flow is to 406 to enable laser output. The laser can be pulsed once per pull of the trigger (“semi-auto” mode) or more than once per single pull of the trigger (“full-auto” mode). Flow continues to 408 subtract “1” from the magazine count. At 410, an audio signal associated with a “fire” action, is played. At 412, the display of the user wrist device or handheld computer is updated at least as to the ammunition count. At 414, a check is made to determine if the user has selected full-auto firing. If no, flow is back to 402 to process another trigger pull. If yes, flow is to 404 to adjust the “mag” count based on the number of times the laser has been pulsed. Once the “mag” count reaches zero, the weapon can no longer fire “ammunition”, and flow is to 416, to notify the user the weapon is out of ammunition, by playing a specific audio signal that indicates to the user that the magazine is empty.

The stored data that can be implemented for the weapon function can include codes for the specific functions, such as EA (play empty audio), MC (mag capacity), FA (play fire audio), RAM (reserve ammo max), RA (reserve ammo), RRA (reload reserve ammo), PL (player level such as novice, expert, etc.), CMC (current mag count), MID (mag ID (identifier)), where MC, RA and RRA can be displayed on the user device. A receiving command to reload reserve ammunition can be a simply flow of receiving the gun ID (identifier) and then bringing the reserve ammunition count to the maximum count allowed.

Gun components can include, but are not limited to, a laser diode, a speaker, a display (e.g., LCD (liquid crystal display)), a reload button, a semi-auto button, a soft-press trigger button, an RF (radio frequency) antenna and an RFID reader in the gun.

Vest components can include, but are not limited to, an RFID reader/writer, force feedback motors (e.g., eleven, for vibrations in response to “hits” to the user wearing the vest), sensor groupings (e.g., ten), and an RF antenna transmitter/receiver (e.g., a UART).

FIG. 4B illustrates a flowchart 418 for a physical magazine reload operation. At 420, the magazine ID on the gun and the magazine ID of the magazine are initialized (set to a value of “1”). At 422, the magazine is ejected. At 424, the top of the magazine is pressed against (held in proximity to) the RFID reader in the user's vest. At 426, a check is made for value of the magazine ID. If the magazine ID value is one, flow is to 428 where the RFID writer of the vest rewrites the magazine ID value to two. At 430, the magazine motor of the vest is pulsed three times for a one-second duration each, at full power. At 426, if the magazine ID value is two, flow is to 432 where the RFID writer of the vest rewrites the magazine ID value to one. At 434, the magazine motor of the vest is pulsed three times for a one-second duration each, at full power.

At 436, the magazine is inserted into the gun. At 438, a check is made to determine if the magazine ID of the magazine matches the magazine ID of the gun. If so, flow is to 440 where the magazine count is raised to the maximum capacity. At 442, the magazine ID on the gun is changed to the secondary number. If at 438, the magazine ID of the magazine does not match the magazine ID of the gun, flow is to 444, where the process ends.

FIG. 4C illustrates a flowchart 446 for an electronic magazine reload operation. At 448, the reload button is pressed. At 450, a check is made for the player level of one or two. If the player level is one, flow is to 452 to subtract the current magazine count with the maximum magazine capacity. Flow is then to 454 to add the number to the current magazine count. At 450, if the player level is two, flow is to 456 to end the process.

FIG. 5 illustrates a flow diagram 500 for sensor input of body hits. At 502, the sensor reads the input laser diode (a binary 100, 1111). At 504, a check is made to determine if the sensors are active. If yes, flow is to 506, to determine the body area ID of the incoming sensor input (BA4). At 508, the body area motor with the matching ID is activated (MBA4). At 510, the binary input is converted to serial (100,111)→(4,15). At 512, the receiver ID, gun ID, vest ID, and sensor grouping (BA) are transmitted. The flow then ends at 514. At 504, if the sensors are not active, flow is to 516 to end the process.

Stored data for can include the received ID (RID), the vest ID (VID), groupings of the sensor in an area of the vest (BA), and force feedback motor next to the correlating sensor grouping in the vest (MBA). Vest inputs can include the RFID reader/writer, force feedback motors (e.g., eleven), sensor grouping (e.g., ten), and one RF antenna via a UART.

In other words, in one implementation, an activity training system is provided, comprising: a sensor system dispersed in association with an activity area in which user activities are conducted, the sensor system senses user status and activity area information as part of the user activities in the activity area; user equipment associated with users performing the user activities in the activity area, the user equipment configured to store and provide user activity data of the users during the user activities in the activity area; a data acquisition and control (DAC) system in communication with the sensor system and the user equipment to process received sensor data, compute activity information, and communicate activity parameters to the activity area; a supervisory system that interfaces to the DAC and enables supervisory functions over the activity area, user activities, and changes to activity area parameters; and a database system that interfaces to the supervisory system and the DAC system, the database system receives the changes to the activity area parameters and immediately propagates the changes to the DAC system to update the activity area parameters.

The activity parameters are changed in a database as the user activities are occurring to cause changes in the activity area during the user activities. The activity parameters are changed during activities in the activity area to provide an advantage or disadvantage to a user. The system can further comprise a personal user device as part of the user equipment that enables the associated user to view activity and user information during activities in the activity area. The user equipment enables tracking of user biometrics during user activities and communication of the biometrics to the supervisory system and the database system in realtime. The supervisory system presents realtime user information and user location in the activity area as one of the supervisory functions. The supervisory system enables one-way and multi-way communications with the users in the activity area. The supervisory system presents a virtual rendering of the activity area and tracks location, movement, and headings of the users in the activity area.

In an alternative implementation, and an activity training system is provided, comprising: a sensor system dispersed in association with an activity area in which user activities are conducted, the sensor system senses user status and activity area information as part of the user activities in the activity area; user equipment associated with users performing the user activities in the activity area, the user equipment configured to store and provide user activity data of the users during the user activities in the activity area; a data acquisition and control (DAC) system in communication with the sensor system and the user equipment to process received sensor data, compute activity information, and communicate activity parameters to the activity area; a supervisory system that interfaces to the DAC and enables supervisory functions over the activity area, user activities, and changes to activity area parameters, and imposition of one or more rules as part of the user activities; and a database system that interfaces to the supervisory system and the DAC system, the database system receives the changes to the activity area parameters and immediately propagates the changes to the DAC system to update the activity area parameters, the database system stores and retrieves an activity set associated with a specific orientation and activity area structure, that when processed, initiates system, user settings, and sensor configurations for the activity set.

The user equipment enables tracking of user biometrics during user activities, location of the user in the activity area, weapons state of one or more weapons employed by a user during activities in the activity area, and wireless communications of user speech during user activities in the activity area, the tracking performed by the DAC system and stored in the database system. The supervisory system enables and monitors one-way and multi-way communications with the users in the activity area. The supervisory system displays a virtual rendering of the activity area, structures in the activity area, user settings, user status information during user activities in the activity area, and displays user location, user movement, and headings of the users in the activity area.

The supervisory system includes an interactive interface that facilitates enablement and disablement of objects in the activity area as users move through the activity area, and enables computation of performance metrics of users in the activity area. The activity area comprises a reconfigurable structure that can be arranged according to specific challenges of which the users are to be tested, and specific physical objects of the structure and in use by the users are enabled for specific users and disabled for other users via the supervisory system during the user activities in the activity area.

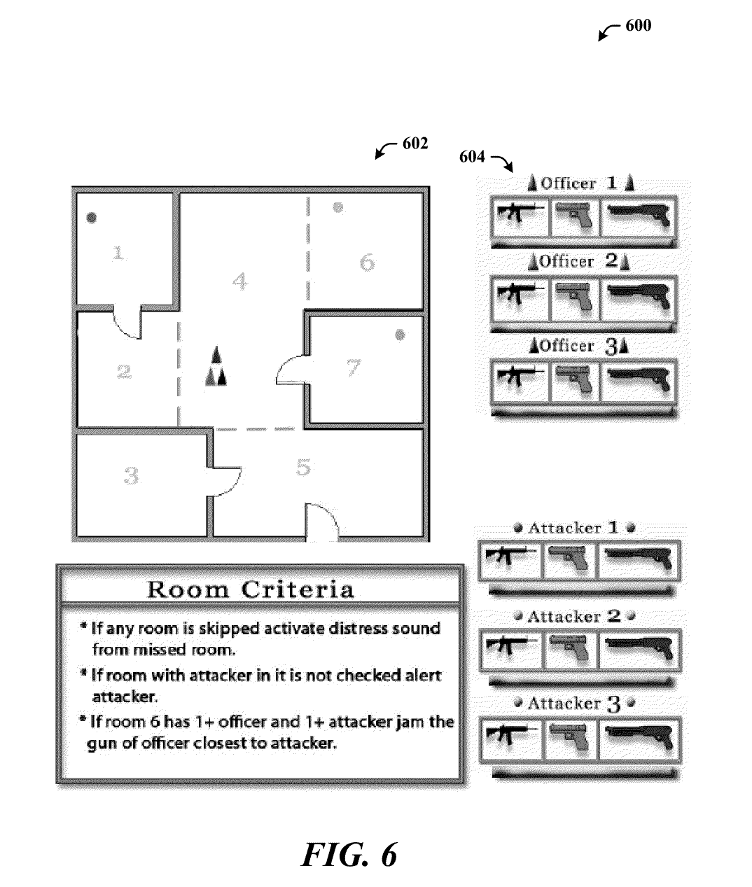

FIGS. 6-19 illustrate various other aspects and exemplary user interfaces that enable a user and administrator to configure and input settings and data to the activities performed in the activity area.

FIG. 6 illustrates a supervisory interface 600 for a training activity. The supervisory interface 600 indicates and tracks the activities and capabilities of three “officers” and three “attackers”, an activity area 602 structured as six rooms, two open areas, four doorways, and a hallway designated as two sections. In this challenge or training exercise, the officers (denoted as three triangles in section four of the hallway), must find the three attackers, who are dispersed in two rooms (room 1 and room 7, and an open area 6. The officers may or may not know the locations of the attackers, but must operate to “clear” the structure in according with room criteria. For example, the room criteria imposed by the supervisor at the supervisory interface 600 can include, but is not limited to, “if any room is skipped, activate a distress sound from the missed room”, if a room with an attacker is not checked, alert the attacker”, and “if room 6 (or open area) has more than one officer and more than one attacker, jam the gun of the closest officer”.

It is to be understood that the supervisor is observing all activities in the activity area, and can change the room criteria dynamically as the officers move through the activity area. It can be the case that at the moment in time, the three officers began the challenge in the open area 4, as shown, and that the clearing exercise begins from that location. Alternatively, the interface 600, the exercise began with the three officers entering the structure 602 through the entry doorway in open area five, as would be the typical process in real situations.

The supervisor interface 600 can also present two groupings of participant status information 604 (e.g., weapons, medical, biometrics, etc.) for the officers and the attackers. Each of the participants can be monitored as to three weapons: rifle, a handgun, and a shotgun. It can be the case that the supervisor assigns a single or multiple weapons to each participant at the beginning of the exercise, or changes the weapons of one or more of the participants as the exercise progresses.

Each of the weapons can be controlled during the exercise, at least with respect to operating or not operating, adjusting the amount of ammunition, imposing different weapon malfunctions such as a failure-to-fire (FTF) state and a failure-to-eject (FTE) status for training weapons that enable that capability, and so on. In such situations, the participant can be monitored as to how effectively the participant moves and interacts (e.g., wirelessly) with other participants, whether officer to attacker, attacker to attacker, and officer to officer, and any of the participants to the supervisor as the exercise progresses through the structure 602. The locations of each of the participants can be monitored using geolocation technology such as GPS, RFID, and/or other locations using sensors that can be used to operate for such purposes.

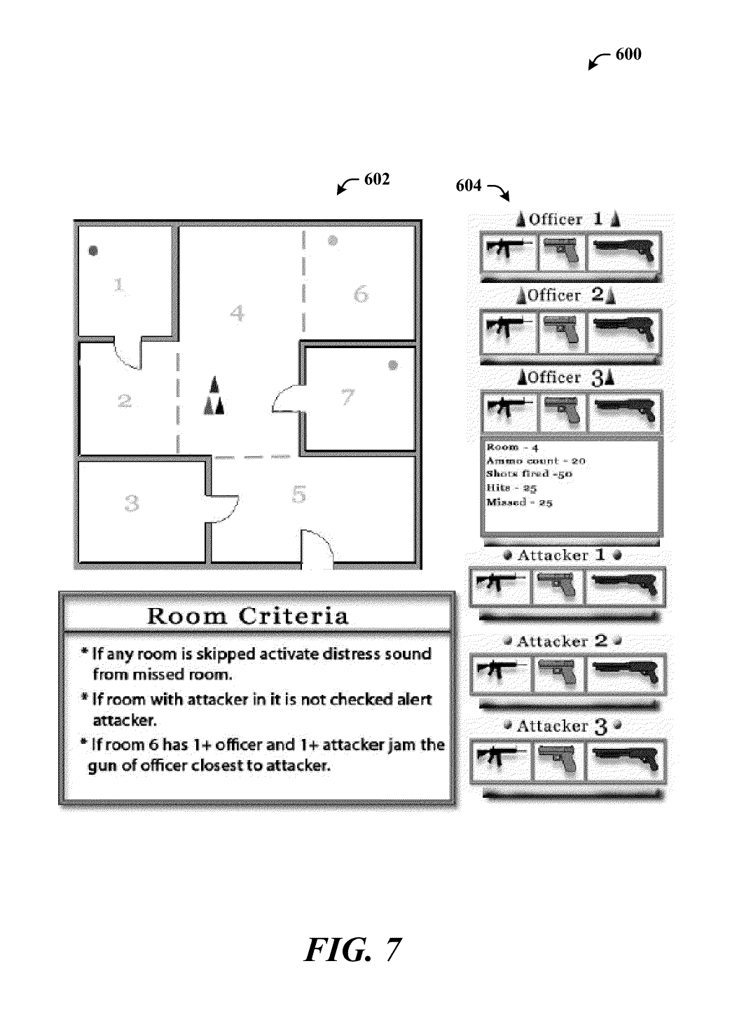

FIG. 7 illustrates the supervisory interface 600 where the supervisor expanded the status information panel for Officer 3, which shows the current location of Officer 3 as room (or open section) 4, the “ammo” count of twenty, shots fired as fifty, the number of targets shot at, as twenty-five, and the number of targets hit as twenty-five. These metrics for each participant can be monitored and adjusted in realtime as the participant is firing the associated weapon, as a target is hit, as a target is missed, as the participant crosses a boundary line (denoted as three dashed lines) from one room to another room (or area), and so on. Note also that the status information can be provided for each weapon the supervisor selects. For example, the count information for the shotgun may be different for the count information for the handgun.

Each participant has an identifiable graphic (visual cue) on the supervisory interface 600 that uniquely distinguishes each participant (e.g., based on color of the graphic) in the structure 602. It can be the case that these graphics (visual cues) can be interactive such that when the supervisor interacts with (selects) the triangle for Officer 3 in the participant status information, the linked (associated) triangle in the structure 602 will be visually activated to more readily assist the supervisor in finding the associate participant. Additionally, the status information for any given participant in the structure 602 can be automatically presented next to the triangle when the supervisor hovers the mouse or other pointing device over the associated triangle object in the structure 602.

The officer information and the attacker information are linked to the respective participant name in the database, so all the data for any given participant can be analyzed for performance against certain criteria for passing or failing the exercise. Additionally, as previously indicated, changing a parameter or parameters in the participant record (or table) in the database will cause the associated action(s) to be dynamically executed for the exercise and for the individual participant. Additionally, the supervisor can monitor all or selected voice communications of the participants before, during, and after the exercise in or outside the structure 602, as well as wirelessly communicate with one or more of the participants, via the supervisory system, before, during, and after the exercise.

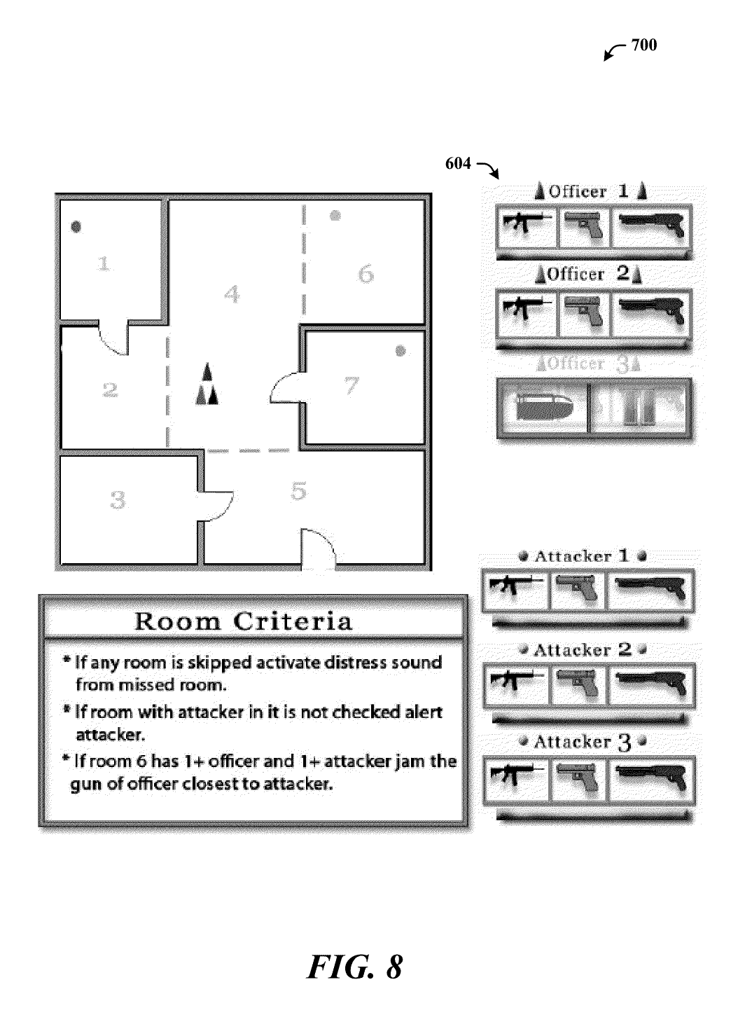

FIG. 8 illustrates the supervisor interface 600 where the participant status information 604 for a participant displays other information. Here, the status information for Officer 3 shows the ammunition types and the number of magazines for that ammunition type, that the participant currently has or is issued at the start of the exercise. It can be the case that the status information for any given participant can be presented to the supervisor and/or participant as audible digital speech, for example, as presented to the supervisor, “Officer 3 has (or “you have” as presented to Office 3) two magazines of handgun ammo left”, or as presented to Officer 3, “you have” two magazines of handgun ammo left”.

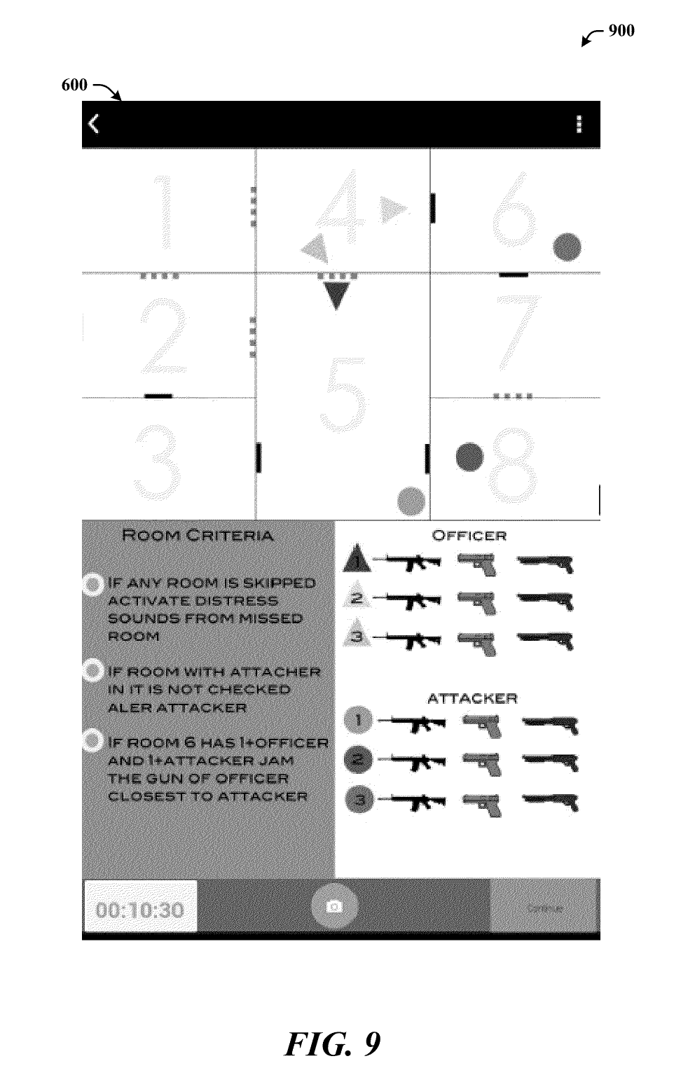

FIG. 9 illustrates a different interface view 900 of the supervisory interface 600 as a configuration page. Here, as in previous views, the heading (the direction the participant is facing) of each participant can also be represented by the orientation of the corresponding participant object (e.g., triangles for officers, and circles or dots for the attackers). At this moment in time, Officer 1 is in room or section 5, and facing South (on the page), Officer 2 is in room or section 4, and facing East, and Officer 3 also in room or section 4, but facing South East. In this case, the heading of the attackers is not shown with the attacker objects as circles or dots. However, objects can be used for any participant that more clearly show heading, where desired.

The supervisory interface 600 for this different interface view 900 can also show the capability to select one or more of the room criteria to impose on the session. The different interface view 900 can also present the actual time (lower left) and/or the elapsed session time (e.g., 00:10:30 for ten minutes and thirty second have elapsed during this session).

An interactive camera object (bottom center of the different interface view 900) can be presented to enable the supervisor to capture session (or exercise) information or state at any point in time. In another implementation, interaction with the camera object and/or a similar object presented at the bottom of the different interface view 900 can also be used to switch to a realtime video camera view of the participant actions currently occurring. Accordingly, the supervisory system can enable the toggling between the realtime actions and the supervisory interface 600 to observe how the immediate imposition of session parameters (e.g., room criteria, locking/unlocking doors, etc.) from changes to the appropriate data in the database, affects participant actions in the activity area. The different interface view 900 also shows the locations of the doors for this current activity area, as well as sensor areas (strings of four dots) positioned throughout the activity area (structure). A “continue” object also enables the supervisor to send the changes or updates to the database to cause the immediate imposition of the changes to the session.

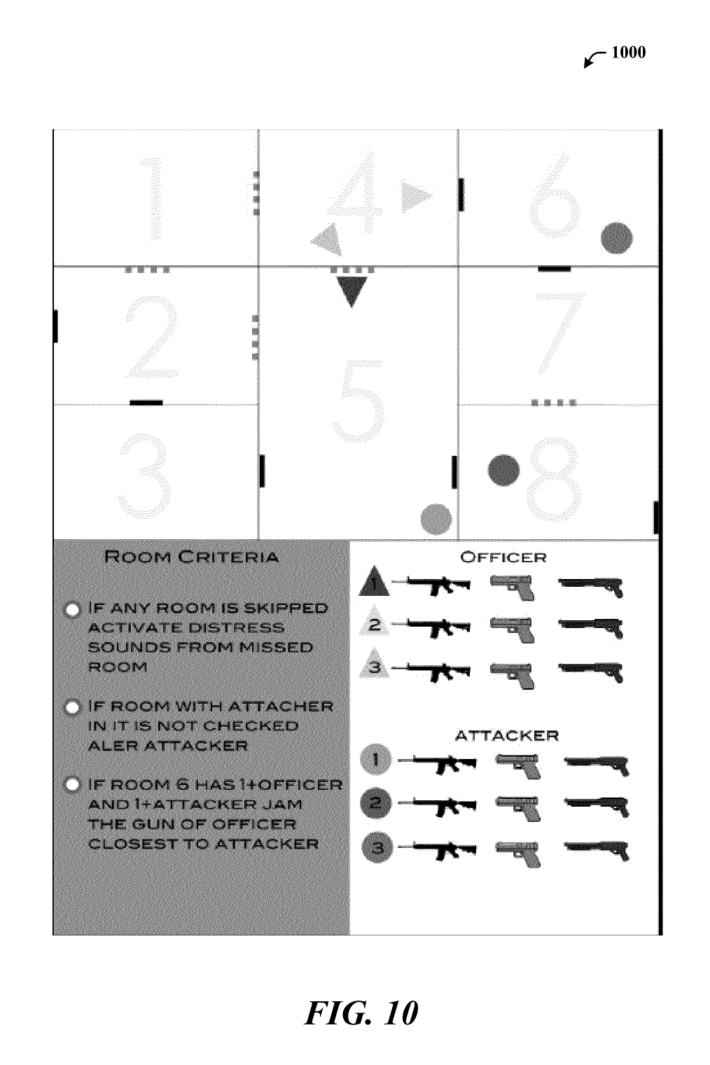

FIG. 10 illustrates the configuration page 1000 as finally submitted to the database to effect actions for the participants for the specific moment in time for the session.

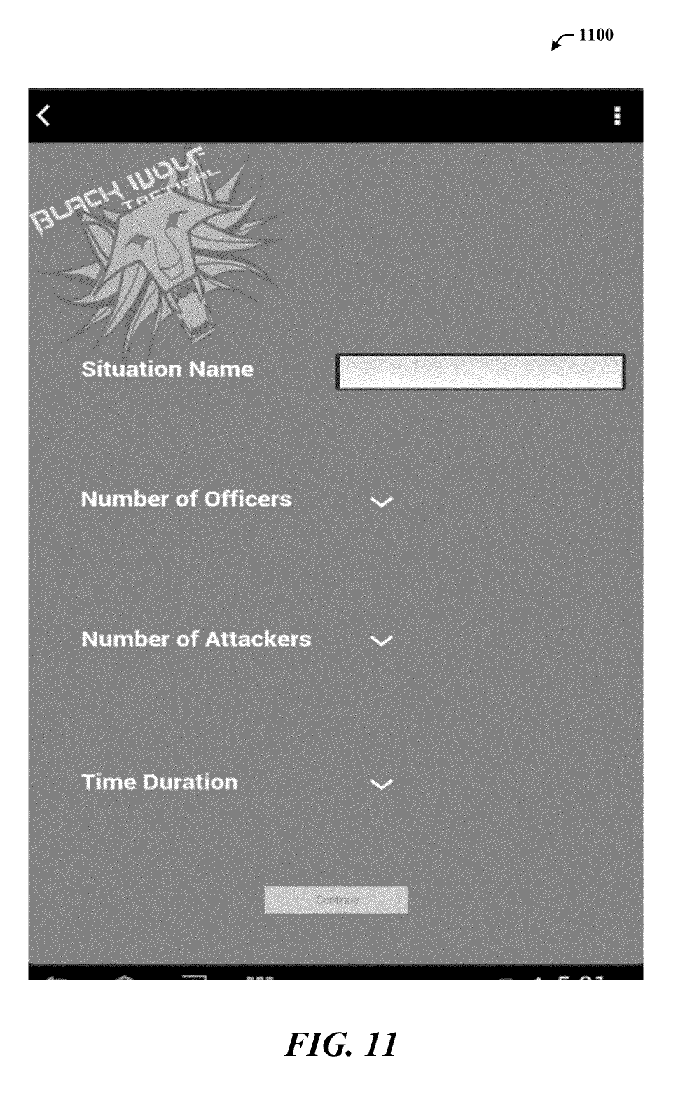

FIG. 11 illustrates a setup page 1100 for generating a session. The setup page 100 can include a field for providing a session name, selecting the number of officers for the session, selecting the number of attackers for the session, and the time duration of the session.

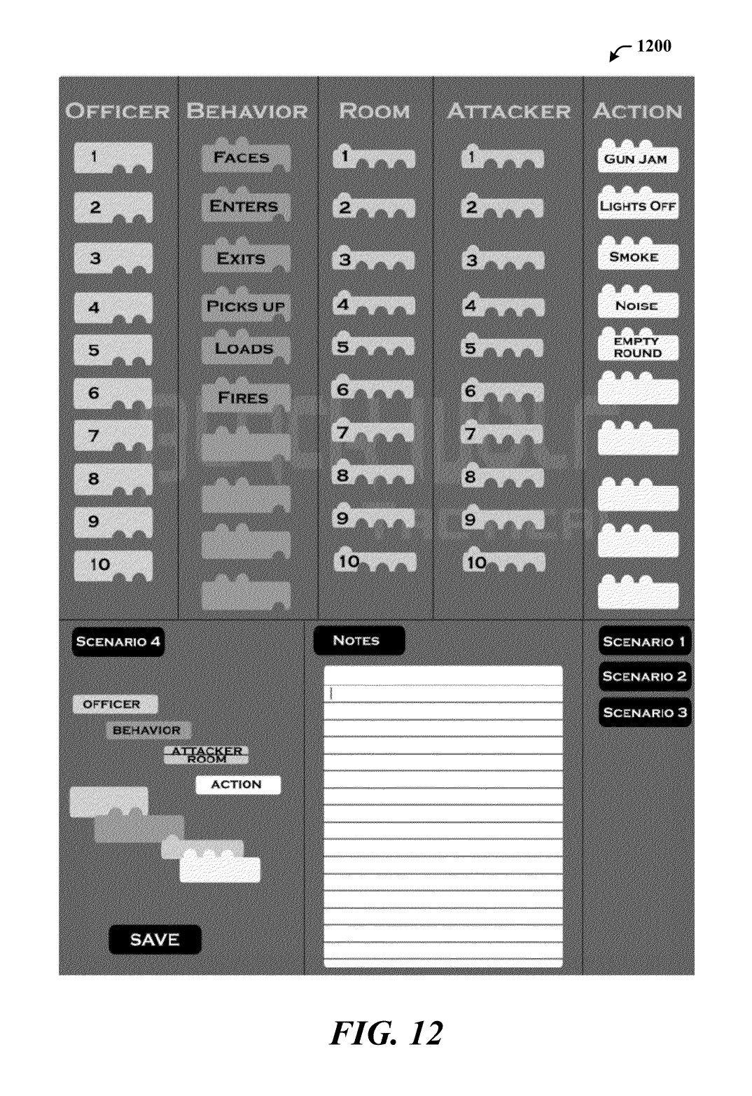

FIG. 12 illustrates a participant configuration page 1200 that enables rules to be configured for behaviors and actions of officers in various scenarios. Here, five rules are configured: a first rule where for a given officer (selectable) that faces a specific attacker (selectable) in association with a specific room (or area), the action is to initiate a gun jam; a second rule where for a given officer (selectable) that enters a certain room and faces a specific attacker (selectable), the action is to turn the lights off; a third rule where for a given officer (selectable) that exits a certain room and faces a specific attacker (selectable), the action is to turn on smoke; a fourth rule where for a given officer (selectable) that picks up an object in a certain room, the action is to initiate a noise; and, a fifth rule where for a given officer (selectable) that performs a load behavior, the action is to initiate an empty round action. A sixth rule simply indicates that for any officer that fires a weapon, no action is taken.

The configuration page also employs distinguishing (“scalloped”—with inverted scalloped design and mating scalloped nodes such that the objects for officer, behavior, room or attacker, and action, interlock) objects for each category: Officer, Behavior, Room, Attacker, and Action. In agreement with the hierarchical representation of the scenario, the scalloped objects present a corresponding hierarchical relationship.

The configuration page 1200 also includes a Notes section where the supervisor can enter notes for any reason, such as for different scenarios, specific participants, etc., and then select Save to save the settings for this configuration.

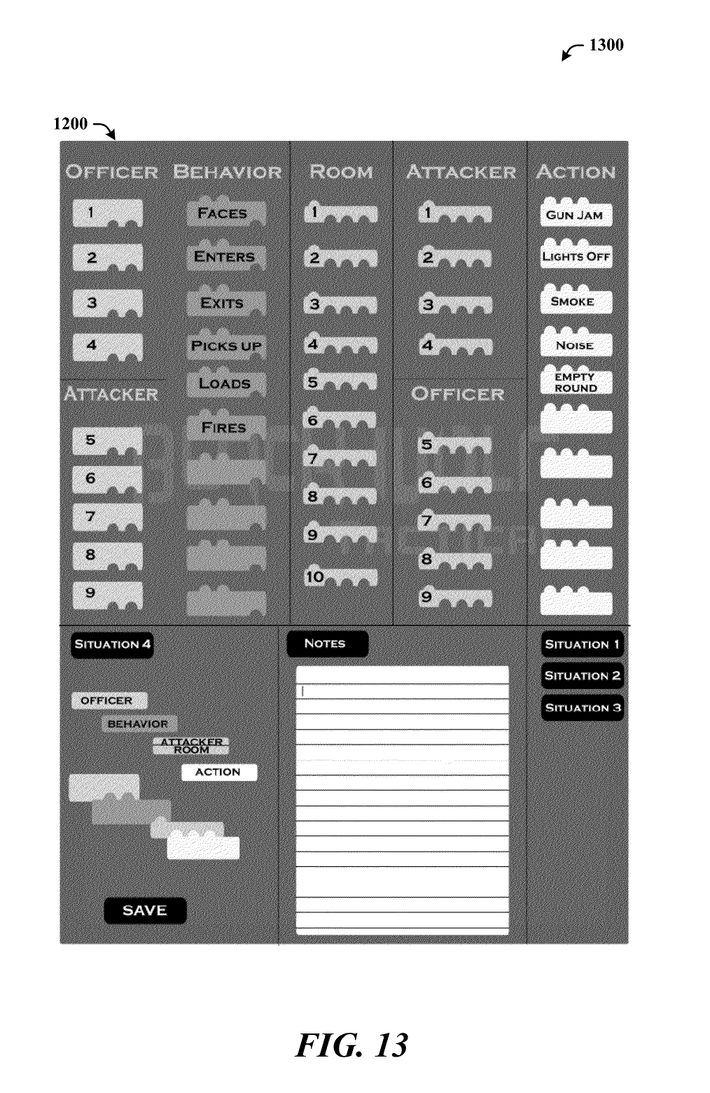

FIG. 13 illustrates a different view 1300 of the participant the configuration page 1200 where rules can be set for the attackers. Thus, the behavior of any given attacker can be configured by on roe more rules. In one example, the behavior of the attacker is to simply fire (shoot an associated weapon).

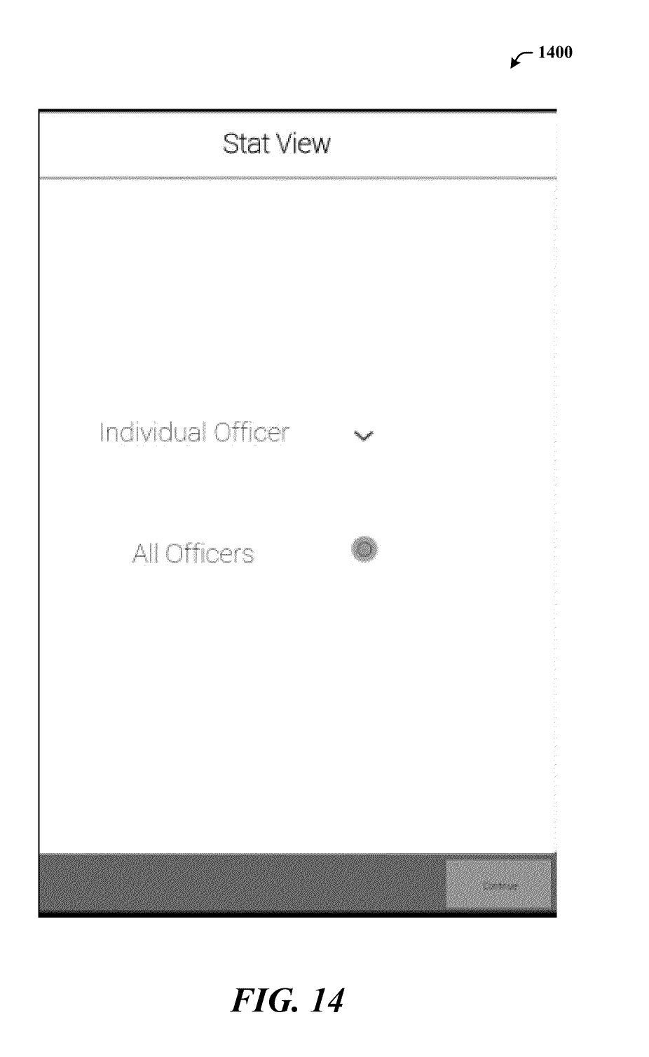

FIG. 14 illustrates a statistics view selection page 1400 that enables the selection of a statistics view for a single officer or all officers. Once selected and executed (selecting a Continue button), the desired window and officer(s) statistics are presented to the supervisor at the supervisory station from where the supervisor monitors and interacts with the session in the activity area.

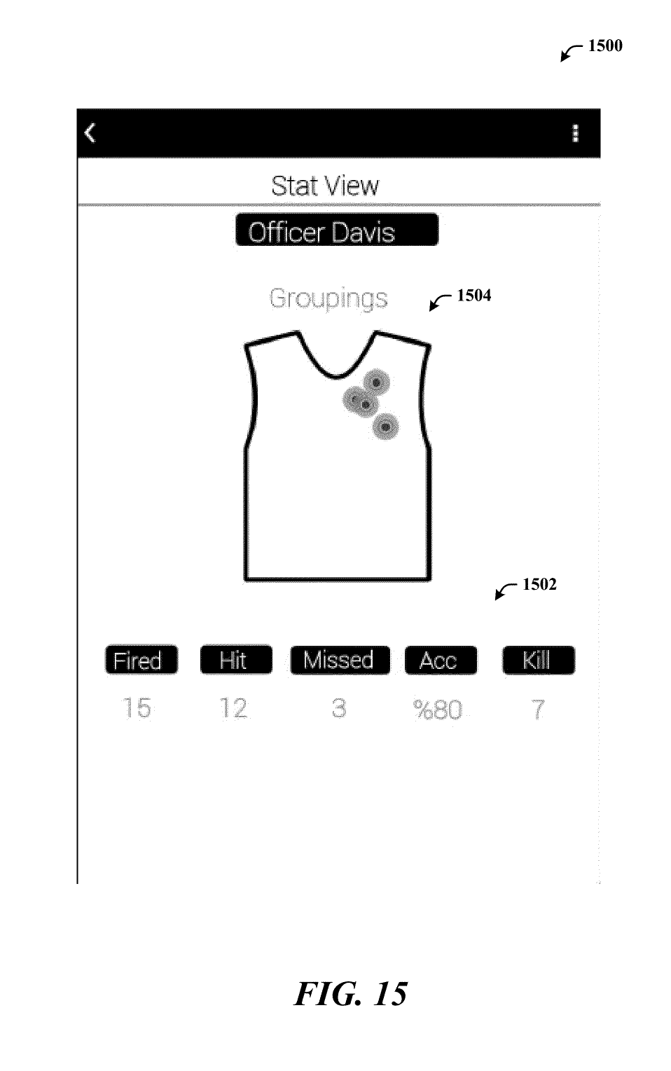

FIG. 15 illustrates a statistical view 1500 of an officer selected in the statistical view selection page of FIG. 14. The statistical view 1500 can include statistics 1502 such as the number of rounds fired (Fired), the number of rounds that impacted a target or attacker (Hits), the number of rounds that missed the target or attacker (Missed), shooting accuracy (Acc) as a percentage in terms of the number of hits over the number of rounds fired, and number of targets or attackers hit to sufficiently remove the target or attacker from the activity or session (Kills). The statistical view 1500 also presents an upper body representation 1504 used to show the locations of rounds on an attacker torso. Here, a grouping of four rounds is shown on the upper left-hand side of the torso of the attacker.

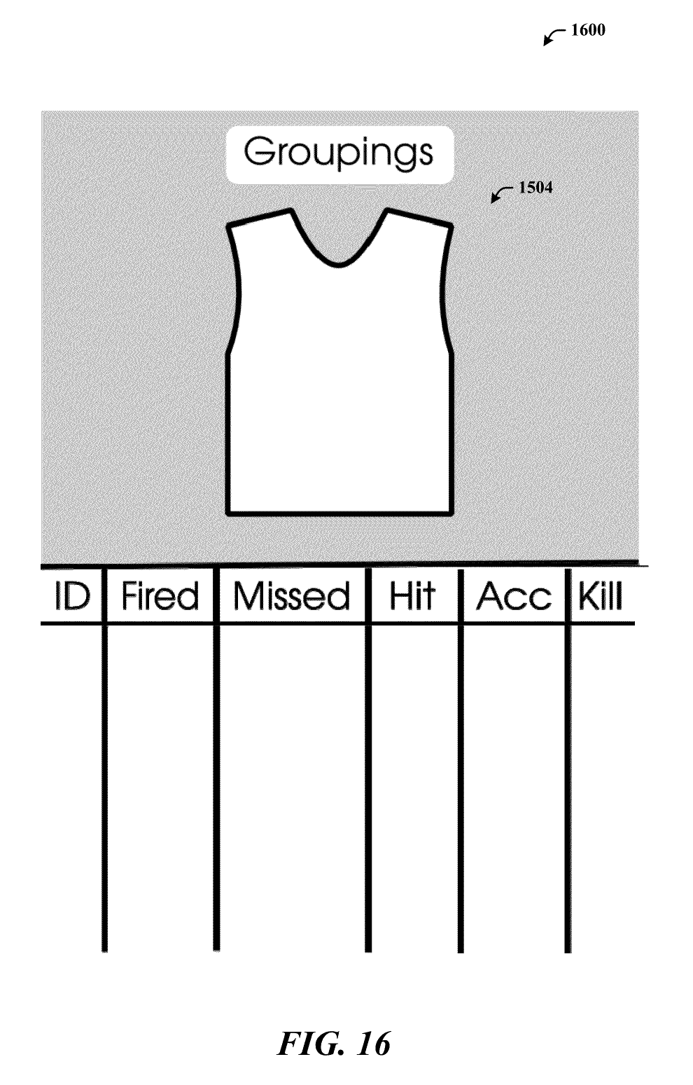

FIG. 16 illustrates a tabular representation 1600 of groupings of an officer against multiple attackers encountered during the session using the statistics shown in FIG. 15. This tabular representation 1600 also enables the retrieval of historical records (or current session records) of a single participant showing the statistics for a given participant against many adversaries identified by an identifier (ID). When the user (e.g., supervisor, participant, etc.) wants to see accumulated statistics for a given participant, the user can then select (click on) a given ID, and the shot grouping can be presented on the upper body representation 1504.

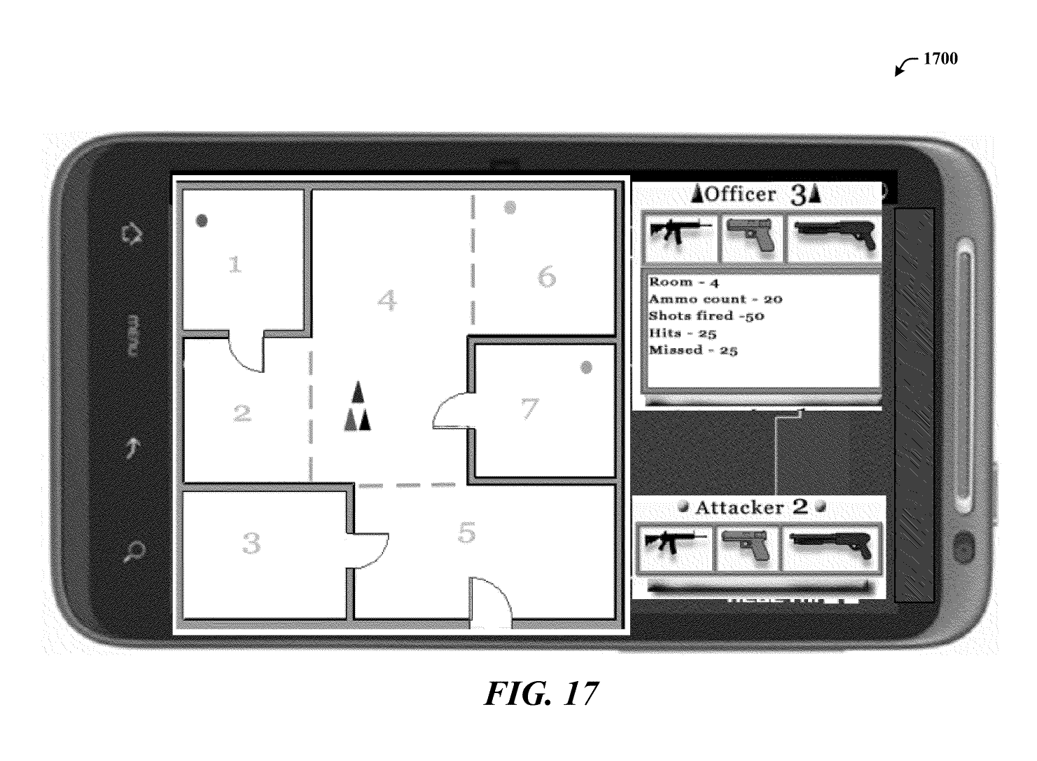

FIG. 17 illustrates a portable device 1700 that can be used to access aspects of the session in the activity area. The disclosed architecture can be designed as an application suitable for operation on small handheld devices such as smartphones, mini-tablets and larger tables, etc. Here, a cellular telephone runs a client that interfaces to the supervisory station and other computing components to receive data and realtime actions occurring in the activity area as well as data past or present. The client application is showing some information similarly presented in the supervisory interface 600 of FIG. 6, such as the structure 602, and officer information and attacker information of the participant status information 604. The user can navigate to other information accessible by the client application to observe activity in the activity area as well as other data.

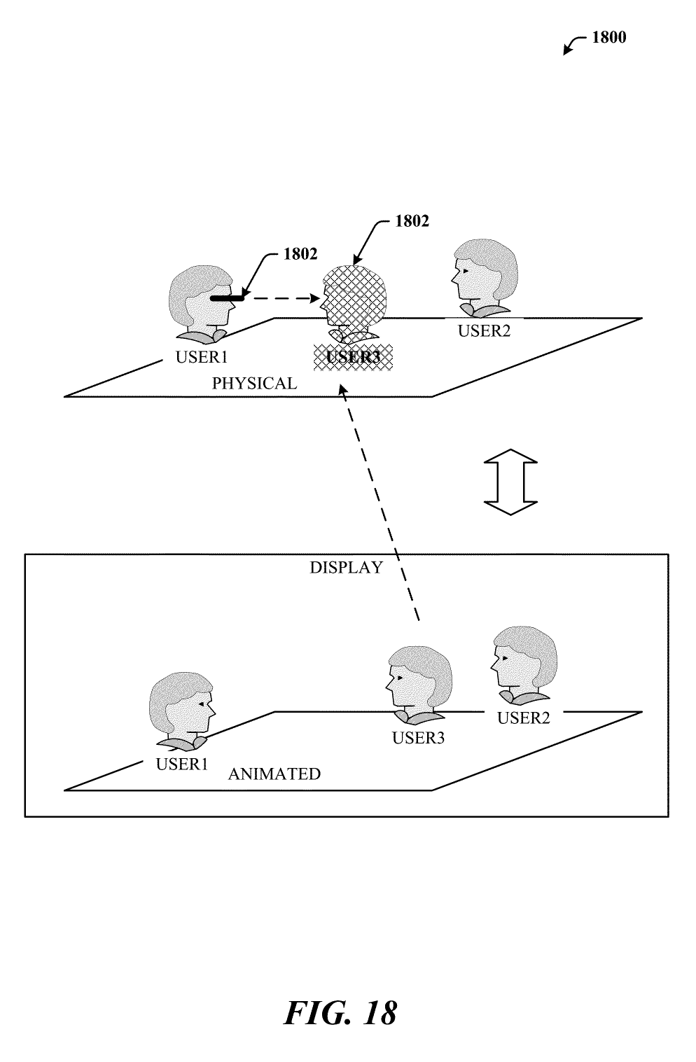

FIG. 18 illustrates a system 1800 where the application of the disclosed architecture can be employed to physical gameplay or training can be realized using computerized gameplay or training and corresponding virtual avatars 1802. For example, real-world play/training in the activity area can be translated to computerized interpretation of the physical play in a virtual rendition of the activity area, using avatars 1802 (virtual animations that represent the actions of the physical users). With this capability, a physical user can compete against a computerized avatar, with other real-world users and avatars 1802, or using any other combinations such as purely computer animated avatars of each of the physical participants in the activity area.

In this implementation, the physical activity area can be digitally recreated and the players (users) tracked using user equipment sensors and activity area sensors such as cameras, location sensors, etc., all tracked and computed in realtime (at or near the time the actual action occurs). Physical movements of the users cause the avatars to move accordingly in the virtual game or activity area of the display. This capability can be further enhanced using augmented reality (AR) glasses 1804. Thus, a trigger pull, a digital bullet fired in the virtual system that hits an avatar, results in the corresponding physical user being hit in the physical activity area. Moreover, since a physical player may be using the AR glasses, an avatar (e.g., avatar 1802) may be projected into the physical activity area that the AR user will see and compete against or play with as a team member.

The trainer (supervisor) can view what is occurring in the building via a computing device (e.g., a tablet) in full 3D rendering as well as from the first person perspective of the people tagged as it is occurring. All playback of what occurred in this 3D environment can be played back. The trainer can choose to replay the events from any of the visual perspectives of the people tracked by the system or place a stand-alone perspective to watch the replay from.)

As previously indicated, described herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

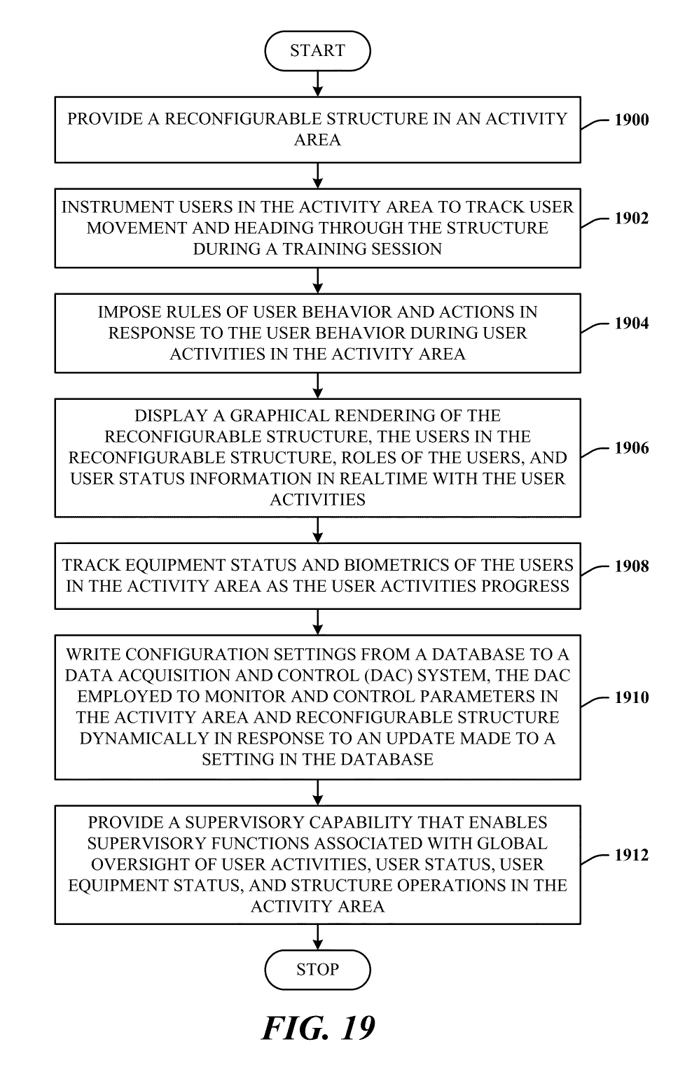

FIG. 19 illustrates a method in accordance with the disclosed architecture. At 1900, a reconfigurable structure is provided in an activity area. The reconfigurable structure can comprise wall, floors, doors, windows, and other commonly used features that are typically encountered in real-world situations. Thus, the structure features can be reconfigured to per the desired arrangement for different raining scenarios and to test specific challenges.

At 1902, users in the activity area are instrumented to track user movement and heading through the structure during a training session. The instrumentation can include the user vest that is equipped to sense user biometrics, user injuries, provide vibrational feedback as to hits or shots fired by other users, to simulate actions normally exhibited by real-world injuries, and so on. At 1904, rules of user behavior and actions in response to the user behavior can be imposed during user activities in the activity area.

At 1906, a graphical rendering of the reconfigurable structure, the users in the reconfigurable structure, roles of the users, and user status information are displayed in realtime with the user activities.

At 1908, equipment status and biometrics of the users are tracked and recorded in the activity area as the user activities progress. This data can be communicated wirelessly (e.g., RFID, via an access point, etc.) continuously or on-demand as the user activities occur in the activity area.

At 1910, configuration settings are written from a database to a data acquisition and control (DAC) system, the DAC employed to monitor and control parameters in the activity area and reconfigurable structure dynamically in response to an update made to a setting in the database. This writing action means to send instructions from the database to the DAC to cause one or more controls to take effect or remain in effect based on the configuration settings, and to take new actions in response to the update.

At 1912, a supervisory capability is provided that enables supervisory functions associated with global oversight of user activities, user status, user equipment status, and structure operations in the activity area. The supervisory interface enables the supervisor to selectively view all facets of the training exercise, ranging from user data, structure configuration, video capture throughout the structure of user activities and events occurring throughout the structure, voice communications occurring between the users, user status information, user movements and headings as the user navigate the activity area and structure, and so on.

The method can further comprises the acts of enabling statistical analysis of user performance during the user activities and reporting of the user performance, displaying shot groupings on a target made by a user during the user activities, providing vibrational feedback to a user of user equipment when the user is impacted by an action of another user, and employing a supervisory function that enables or disables some or all operations of a piece of user equipment during the user activities in the activity area.

As used in this application, the term “component” is intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

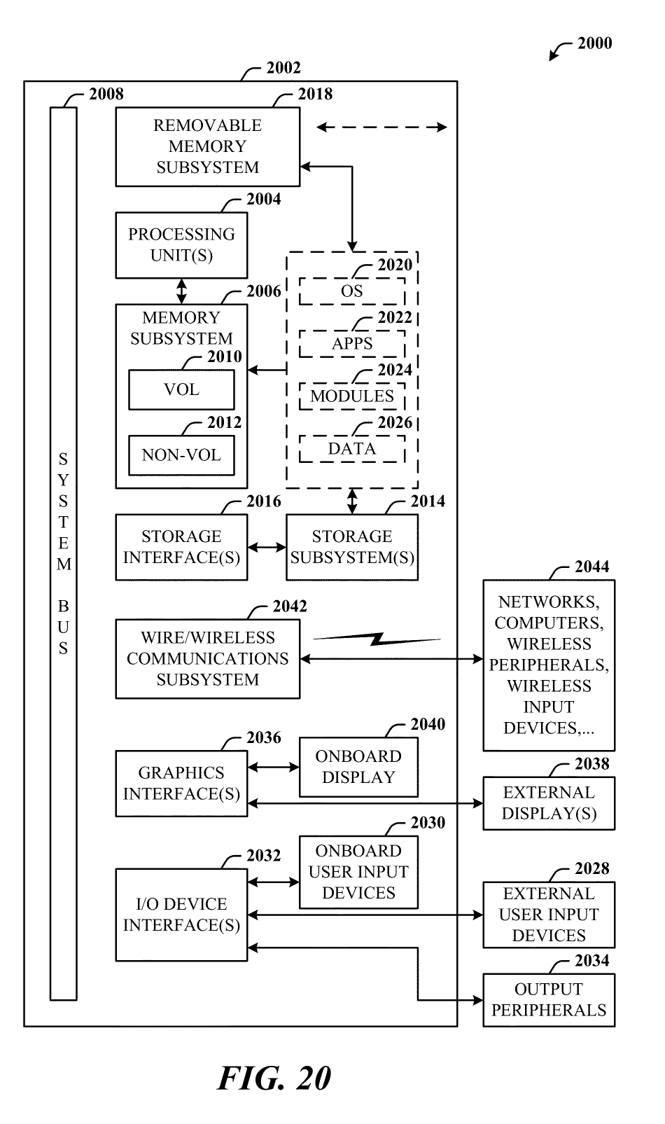

Referring now to FIG. 20, there is illustrated a block diagram of a computing system 2000 that enables setup, configuration and user interaction with an activity environment and data acquisition for user activity processing in an activity area in accordance with the disclosed architecture.

In order to provide additional context for various aspects thereof, FIG. 20 and the following description are intended to provide a brief, general description of the suitable computing system 2000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 2000 for implementing various aspects includes the computer 2002 having processing unit(s) 2004 (also referred to as microprocessor(s) and processor(s)), a computer-readable storage medium such as a system memory 2006 (computer readable storage medium/media also include magnetic disks, optical disks, solid state drives, external memory systems, and flash memory drives), and a system bus 2008. The processing unit(s) 2004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 2002 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 2006 can include computer-readable storage (physical storage) medium such as a volatile (VOL) memory 2010 (e.g., random access memory (RAM)) and a non-volatile memory (NON-VOL) 2012 (e.g., ROM, EPROM, EEPROM, etc.). A basic input/output system (BIOS) can be stored in the non-volatile memory 2012, and includes the basic routines that facilitate the communication of data and signals between components within the computer 2002, such as during startup. The volatile memory 2010 can also include a high-speed RAM such as static RAM for caching data.

The system bus 2008 provides an interface for system components including, but not limited to, the system memory 2006 to the processing unit(s) 2004. The system bus 2008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 2002 further includes machine readable storage subsystem(s) 2014 and storage interface(s) 2016 for interfacing the storage subsystem(s) 2014 to the system bus 2008 and other desired computer components. The storage subsystem(s) 2014 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 2016 can include interface technologies such as EIDE, ATA, SATA, and IEEE 1394, for example.

One or more programs and data can be stored in the memory subsystem 2006, a machine readable and removable memory subsystem 2018 (e.g., flash drive form factor technology), and/or the storage subsystem(s) 2014 (e.g., optical, magnetic, solid state), including an operating system 2020, one or more application programs 2022, other program modules 2024, and program data 2026.

The operating system 2020, one or more application programs 2022, other program modules 2024, and/or program data 2026 can include entities and components of the system 100 of FIG. 1, and capabilities exhibited in and by the other figures, for example.

Generally, programs include routines, methods, data structures, other software components, etc., that perform particular tasks or implement particular abstract data types. All or portions of the operating system 2020, applications 2022, modules 2024, and/or data 2026 can also be cached in memory such as the volatile memory 2010, for example. It is to be appreciated that the disclosed architecture can be implemented with various commercially available operating systems or combinations of operating systems (e.g., as virtual machines).

The storage subsystem(s) 2014 and memory subsystems (2006 and 2018) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 2002, and include volatile and non-volatile internal and/or external media that is removable and/or non-removable. For the computer 2002, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 2002, programs, and data using external user input devices 2028 such as a keyboard and a mouse, as well as by voice commands facilitated by speech recognition. Other external user input devices 2028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 2002, programs, and data using onboard user input devices 2030 such a touchpad, microphone, keyboard, etc., where the computer 2002 is a portable computer, for example.

These and other input devices are connected to the processing unit(s) 2004 through input/output (I/O) device interface(s) 2032 via the system bus 2008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 2032 also facilitate the use of output peripherals 2034 such as printers, audio devices, camera devices, and so on, such as a sound card and/or onboard audio processing capability.

One or more graphics interface(s) 2036 (also commonly referred to as a graphics processing unit (GPU)) provide graphics and video signals between the computer 2002 and external display(s) 2038 (e.g., LCD, plasma) and/or onboard displays 2040 (e.g., for portable computer). The graphics interface(s) 2036 can also be manufactured as part of the computer system board.

The computer 2002 can operate in a networked environment (e.g., IP-based) using logical connections via a wired/wireless communications subsystem 2042 to one or more networks and/or other computers. The other computers can include workstations, servers, routers, personal computers, microprocessor-based entertainment appliances, peer devices or other common network nodes, and typically include many or all of the elements described relative to the computer 2002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 2002 connects to the network via a wired/wireless communication subsystem 2042 (e.g., a network interface adapter, onboard transceiver subsystem, etc.) to communicate with wired/wireless networks, wired/wireless printers, wired/wireless input devices 2044, and so on. The computer 2002 can include a modem or other means for establishing communications over the network. In a networked environment, programs and data relative to the computer 2002 can be stored in the remote memory/storage device, as is associated with a distributed system. It will be appreciated that the network connections shown are exemplary and other means of establishing a communications link between the computers can be used.

The computer 2002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An activity training system, comprising:
a sensor system dispersed in association with an activity area in which user activities are conducted, the sensor system senses user status and activity area information as part of the user activities in the activity area;
user equipment associated with users performing the user activities in the activity area, the user equipment configured to store and provide user activity data of the users during the user activities in the activity area;
a data acquisition and control (DAC) system in communication with the sensor system and the user equipment to process received sensor data, compute activity information, and communicate activity parameters to the activity area;
a supervisory system that interfaces to the DAC and enables supervisory functions over the activity area, user activities, and changes to activity area parameters; and
a database system that interfaces to the supervisory system and the DAC system, the database system receives the changes to the activity area parameters and immediately propagates the changes to the DAC system to update the activity area parameters.

2. The system of claim 1, wherein the activity parameters are changed in a database as the user activities are occurring to cause changes in the activity area during the user activities.

3. The system of claim 1, wherein the activity parameters are changed during activities in the activity area to provide an advantage or disadvantage to a user.

4. The system of claim 1, further comprising a personal user device as part of the user equipment that enables the associated user to view activity and user information during activities in the activity area.

5. The system of claim 1, wherein the user equipment enables tracking of user biometrics during user activities and communication of the biometrics to the supervisory system and the database system in realtime.

6. The system of claim 1, wherein the supervisory system presents realtime user information and user location in the activity area as one of the supervisory functions.

7. The system of claim 1, wherein the supervisory system enables one-way and multi-way communications with the users in the activity area.

8. The system of claim 1, wherein the supervisory system presents a virtual rendering of the activity area and tracks location, movement, and headings of the users in the activity area.

9. An activity training system, comprising:
a sensor system dispersed in association with an activity area in which user activities are conducted, the sensor system senses user status and activity area information as part of the user activities in the activity area;
user equipment associated with users performing the user activities in the activity area, the user equipment configured to store and provide user activity data of the users during the user activities in the activity area;
a data acquisition and control (DAC) system in communication with the sensor system and the user equipment to process received sensor data, compute activity information, and communicate activity parameters to the activity area;
a supervisory system that interfaces to the DAC and enables supervisory functions over the activity area, user activities, and changes to activity area parameters, and imposition of one or more rules as part of the user activities; and
a database system that interfaces to the supervisory system and the DAC system, the database system receives the changes to the activity area parameters and immediately propagates the changes to the DAC system to update the activity area parameters, the database system stores and retrieves an activity set associated with a specific orientation and activity area structure, that when processed, initiates system, user settings, and sensor configurations for the activity set.

10. The system of claim 9, wherein the user equipment enables tracking of user biometrics during user activities, location of the user in the activity area, weapons state of one or more weapons employed by a user during activities in the activity area, and wireless communications of user speech during user activities in the activity area, the tracking performed by the DAC system and stored in the database system.

11. The system of claim 9, wherein the supervisory system enables and monitors one-way and multi-way communications with the users in the activity area.

12. The system of claim 9, wherein the supervisory system displays a virtual rendering of the activity area, structures in the activity area, user settings, user status information during user activities in the activity area, and displays user location, user movement, and headings of the users in the activity area.

13. The system of claim 9, wherein the supervisory system includes an interactive interface that facilitates enablement and disablement of objects in the activity area as users move through the activity area.

14. The system of claim 9, wherein the supervisory system enables computation of performance metrics of users in the activity area.

15. The system of claim 9, wherein the activity area comprises a reconfigurable structure that can be arranged according to specific challenges of which the users are to be tested, and specific physical objects of the structure and in use by the users are enabled for specific users and disabled for other users via the supervisory system during the user activities in the activity area.

16. A method of activity training, comprising acts of:
providing a reconfigurable structure in an activity area;
instrumenting users in the activity area to track user movement and heading through the structure during a training session;
imposing rules of user behavior and actions in response to the user behavior during user activities in the activity area;
displaying a graphical rendering of the reconfigurable structure, the users in the reconfigurable structure, roles of the users, and user status information in realtime with the user activities;
tracking equipment status and biometrics of the users in the activity area as the user activities progress;
writing configuration settings from a database to a data acquisition and control (DAC) system, the DAC employed to monitor and control parameters in the activity area and reconfigurable structure dynamically in response to an update made to a setting in the database; and
providing a supervisory capability that enables supervisory functions associated with global oversight of user activities, user status, user equipment status, and structure operations in the activity area.

17. The method of claim 16, further comprising enabling statistical analysis of user performance during the user activities and reporting of the user performance.

18. The method of claim 16, further comprising displaying shot groupings on a target made by a user during the user activities.

19. The method of claim 16, further comprising providing vibrational feedback to a user of user equipment when the user is impacted by an action of another user.

20. The method of claim 16, further comprising employing a supervisory function that enables or disables some or all operations of a piece of user equipment during the user activities in the activity area.
